(19) United States
(12) Patent Application Publication
(10) Pub. No.: US 2025/0066224 A1
(43) Pub. Date: Feb. 27, 2025

(54) DECONTAMINATION APPARATUS, KITS, METHODS, AND SYSTEMS

(71) Applicant: ClearBlue Ionizer Inc., Mississauga (CA)

(72) Inventor: Michael Assad, Naples, FL (US)

(73) Assignee: ClearBlue Ionizer Inc., Mississauga (CA)

(21) Appl. No.: 18/811,231

(22) Filed: Aug. 21, 2024

Related U.S. Application Data
(60) Provisional application No. 63/533,815, filed on Aug. 21, 2023.

(51) Int. Cl. C02F 1/42; E04H 4/12

(52) U.S. Cl. CPC C02F 1/42; E04H 4/1209; C02F 2001/425

(57) ABSTRACT

Decontamination apparatus, kits, methods, and systems are described. One apparatus comprises: a mineral cell comprising electrode plates and a pin comprising contacts; and a power source comprising a plug defining a chamber, a shaft extending into the chamber, and conductors in the chamber, the mineral cell being removably attachable to and operably submergible under water with the power source by inserting the pin through the shaft to establish: an electrical connection in the chamber between the contacts and the conductors; and a seal that prevents the water from entering the chamber when the electrode plates are submerged in the water and electrified via the electrical connection. Related apparatus, kits, methods, and systems are described.

### CROSS-REFERENCE TO RELATED APPLICATIONS

This application claims the benefit of priority under 35 U.S.C. § 119 to U.S. Prov. Patent App. No. 63/533,815, filed Aug. 21, 2023, the entirety of which is hereby incorporated by reference.

### TECHNICAL FIELD

Aspects of this disclosure relate generally to a decontamination apparatus, kits, methods, and systems. Particular aspects relate to water decontamination for pools and tubs.

### BACKGROUND

Pool ionizers are effective at controlling algae in pool water and allowing for reductions in algaecide, chlorine, and pH balancing chemicals in the water. Some pool ionizers use a mineral cell to build up minerals in the water. These cells have a lifespan that ranges from three months to three years and when it runs out, the ionizer stops working. Mineral cells may cost hundreds of dollars to replace, adding costs that must be accounted for when budgeting for pool maintenance. Further technological improvements are required to manage these and related operating costs.

### BRIEF SUMMARY

One aspect of this application is an apparatus. For example, the apparatus may comprise: a mineral cell comprising electrode plates and a pin comprising contacts; and a power source comprising a plug defining a chamber, a shaft extending into the chamber, and conductors in the chamber, the mineral cell being removably attachable to and operably submergible under water with the power source by inserting the pin through the shaft to establish an electrical connection in the chamber between the contacts and the conductors; and a seal that prevents the water from entering the chamber when the electrode plates are submerged in the water and electrified via the electrical connection.

The electrode plates may comprise a pair of metal alloy electrodes. The pair of metal alloy electrodes may be elongated to define opposing surface areas having rectangular perimeter shapes.

The mineral cell may comprise a first wall, a second wall, and a sidewall extending between the first wall and the second wall to define a chamber. The pin may comprise a first portion that extends outwardly from the first wall to locate the contacts outside of the chamber and a second portion that is electrically connected to the electrode plates inside the chamber. The first portion may cantilever out from the first wall. The first portion may comprise a base that is sized to fit in the shaft and operable with interior surfaces of the plug and the shaft to establish the seal. An outer diameter of the base may be sized to obtain a clearance fit with an inner diameter of the shaft.

The base may comprise a groove. The seal may comprise an O-ring that is contained in the groove and has exterior surfaces operable with interior surfaces of the shaft to prevent the water from entering the chamber. The O-ring may be compressible to permit entry of the pin into the shaft and expandable to seal the chamber. The second portion of the pin may be removably attach to the first wall with a sealed connection that prevents the water from entering the chamber.

The pin may comprise a flange located between the first portion and the second portion. The first wall may comprise a recess sized to obtain a clearance fit with an outer diameter of the flange. The sealed connection may comprise an O-ring located in the recess below the flange. The apparatus may comprise a nut comprising threads operable with corresponding threads on the second portion to removably attach the pin to the front wall. The pin may comprise a first conductor extending through the pin and terminating at a first contact of the contacts; a second conductor extending through the pin and terminating at a second contact of the contacts; and an electrical insulator extending through the pin to prevent electricity from conducting between the first conductor and the second conductor. The first conductor may be located in a central portion of pin. The second conductor may be located in an outer portion of the pin. The electrical insulator may be located between and adhered to first conductor and the second conductor. The seal may comprise an O-ring surrounding the first conductor, the second conductor, and the electrical insulator. The O-ring may be compressible to permit entry of the pin into the shaft and expandable to seal the chamber.

The first conductor may comprise a stem extending through the central portion and a head located forward of the electrical insulator. The first contact may comprise the head. The second conductor may comprise a tube surrounding the stem. The second contact may comprise an end portion of the tube. The electrical insulator may be located between the head, the stem, and the tube. Each conductor of the conductors may be operable, when the pin may be located in the shaft, to apply a biasing force that maintains a physical contact between a surface of the conductor and a corresponding surface of one contact of the contacts.

The electrode plates may comprise a first electrode plate and a second electrode plate. The contacts may comprise a first contact electrically connected to the first electrode plate and a second contact electrically may be connected to the second electrode plate. The conductors may comprise a first conductor operable to electrify the first electrode plate via the first contact and a second conductor operable to electrify the second electrode plate via the second contact when the pin is located in the shaft.

When the pin is located in shaft, the first conductor may apply a first biasing force to the first contact and the second conductor may apply a second biasing force to the second contact. The first conductor may comprise a first spring contact operable to apply the first biasing force to the first contact and the second conductor may comprise a second spring contact operable to apply the second biasing force to the second contact. The first and second contacts may comprise grooves. The first and second spring contacts may comprise protrusions. The first and second biasing forces may be operable to retain the pin in the shaft by pressing the protrusions into the grooves.

The mineral chamber may comprise a chamber. The first contact may electrically connect to the first electrode plate in the chamber. The second contact may electrically connect to the second electrode plate in the chamber. The apparatus may comprise a nut that is located in the chamber and comprises threads operable with corresponding threads on the pin to: removably attach the pin to the mineral cell; and establish a sealed connection that prevents the water from entering the chamber. The apparatus may comprise a first intermediate connector that is located in the chamber to electrically connect the first conductor and the first electrode plate and a second intermediate connector that is located in the chamber to electrically connect the second conductor and the second electrode plate.

The apparatus may comprise a first conductive screw that electronically connects the first intermediate conductor with the first electrode plate and removably attaches the first electrode plate to a support wall of the mineral cell; and a second conductive screw that may electronically connect the second intermediate conductor with the second electrode plate and may removably attach the second electrode plate to the support wall. The first conductive screw and the second conductive screw may pass through holes in the support wall. The apparatus may comprise an epoxy that is located in the chamber and operable to prevent water from entering the chamber through the holes.

The seal may comprise a perimeter wall that may extend outwardly from the mineral cell around the pin. The plug may interface with the perimeter wall and the mineral cell when the pin is inserted into the shaft to establish a perimeter seal that prevents the water from entering the shaft when the electrode plates are submerged in the water and electrified via the electrical connection. The perimeter seal may comprise a friction fit obtained between exterior surfaces of the plug and interior surfaces of the perimeter wall. The perimeter wall may be operable with the plug to maintain a position of the power source relative to the mineral cell. The perimeter wall may be operable with the plug to obtain a press fit between the plug and the mineral cell. Threads on the perimeter wall may be operable with threads on the plug to maintain the press fit.

The plug may comprise a first locking element. The perimeter wall may comprise a second locking element. The first locking element may be operable with the second locking element to lock the power source onto the mineral cell housing. The first locking element and second locking element may form a bayonet lock operable to lock the power source onto the mineral cell housing. The apparatus may comprise a surround that extends outwardly from the plug to define an annular space sized to receive the perimeter wall when inserting the pin through the shaft to establish: an outer seal between surfaces of the perimeter wall, interior surfaces of the surround, and exterior surfaces of the plug; and an inner seal between exterior surfaces of the pin and interior surfaces of the shaft.

The interior surfaces of the surround may comprise a first locking element. The perimeter wall may comprise a second locking element. The first locking element may be operable with the second locking element to lock the power source onto the mineral cell housing. The apparatus may comprise a conduit that is removably attached to the mineral cell and operable to direct flows of the water across the electrode plates. The apparatus may comprise a sensor that is operable to output sensory data associated with the electrode plates and the water. The apparatus may comprise an LED that is located on the plug and operable responsive to the sensor. The apparatus may comprise a data transceiver that is located on the plug and operable to communicate the sensory data to a remote processor over a wireless network.

In each of these examples, a first end of the power source may be rigidly attached to a controller and a second end of the power source may be removably attachable to and operably submergible with the mineral cell.

Another aspect of this application is a system. For example, the system may comprise a plurality of mineral cells like those described above and herein, and at least one power source like those described above and herein. Each mineral cell plurality of mineral cells may be interchangeably replaceable with one another. The system may comprise of a conduit that is removably attachable to the mineral cell and operable to direct water across the electrode plates. The conduit may be removably attachable to the mineral cell and a portion of a pool or tub. The system may comprise a mount operable to removably attach one or both of the conduit and the mineral cell to the pool or tub. Any variation of the system may comprise the pool or tub and/or be sold therewith.

Another aspect of this application is a method. For example, the method may comprise removably attaching a power source comprising a shaft leading to a chamber to a mineral cell comprising electrode plates and a pin. In this example, the method may comprise inserting the pin through the shaft to establish: an electrical connection in the chamber between contacts on the pin and conductors that are located in the chamber and electrically connected to the electrode plates; and a seal that prevents the water from entering the chamber when the electrode plates are submerged in the water and electrified via the electrical connection.

The method my comprise maintaining the seal by locking the pin in the shaft. The method may comprise inserting the pin through the shaft to establish a perimeter seal that prevents the water from entering the shaft when the electrode plates are submerged in the water and electrified via the electrical connection. Establishing the seal may comprise locating an O-ring between exterior surfaces of the pin and interior surfaces of the shaft. The method may comprise compressing the O-ring to permit entry of the pin into the shaft and expanding the O-ring to seal the shaft. Establishing the electrical connection may comprise placing each contact of the contacts against a spring conduct of the conductors; and applying, with each spring contact, a biasing force toward the pin that maintains a physical contact between the contact and the spring contact when the pin is located in the shaft.

The method may comprise operatively submerging the electrode plates in water and electrifying the electrode plates via the conductors and the contacts while preventing water from entering the chamber with the seal and the perimeter seal. The method may comprise generating, with a sensor that is located on the power source and powered by the conductors, sensory data associated with the electrode plates or the water. The method may comprise outputting, with an LED that is located on the power source and powered by the conductors, a visual indicator responsive to the sensory data. The method may comprise outputting, with a data transmitter that is located on the power source and powered by the conductors, the sensory data to a remote processor over a wireless network. The method may comprise generating, with the remote processor, based on the sensory data, a replacement communication associated with the mineral cell. The method may comprise ordering, with the remote processor, based on the sensory data, a new mineral cell responsive to the replacement communication. The method may comprise ordering, with the remote processor, based on the sensory data, a kit for rebuilding the mineral cell responsive to the replacement communication.

Related aspects of decontamination apparatus, kits, methods, and systems also are disclosed, including particular aspects related to water decontamination for pools and tubs.

### BRIEF DESCRIPTION OF THE DRAWINGS

The accompanying drawings, which are incorporated in and constitute part of this disclosure, illustrate exemplary aspects that, together with the written descriptions, serve to explain the principles of this disclosure. Numerous aspects are shown conceptually in the drawings and particularly described, pointed out, and taught in the written descriptions. Some structural and operational aspects may be better understood by referencing the written portions together with the accompanying drawings, of which:

FIG. 1 depicts a perspective view of a system comprising a pool or tub and decontamination apparatus operable to decontaminate water in the pool or tub.

FIG. 2 depicts the FIG. 1 system in which the decontamination apparatus mounted within a submergible enclosure of the pool or tub.

FIG. 3 depicts a perspective view of an exemplary decontamination apparatus comprising a power source, a mineral cell, and a conduit.

FIG. 4 depicts a profile view of the FIG. 3 apparatus.

FIG. 5 depicts exploded views of the FIG. 3 apparatus.

FIG. 6 depicts a cross-sectional view of the FIG. 3 apparatus.

FIG. 7 depicts an exemplary mineral cell without electrode plates.

FIG. 8 depicts an exemplary mineral cell with electrode plates.

FIG. 9 depicts a side view of the FIG. 8 cell without the electrode plates.

FIG. 10 depicts a cross-sectional view of a housing of the FIG. 8 cell.

FIG. 11 depicts a perspective views of an exemplary pin and power source.

FIG. 12 depicts a cross-sectional view of the FIG. 11 pin and power source.

FIG. 13 depicts a perspective view of the FIG. 8 cell and the power source.

FIG. 14 depicts a side view FIG. 8 cell attached to a power source.

FIG. 15 depicts a section view of the FIG. 14 cell and power source.

FIG. 16 depicts an exploded view of an exemplary decontamination apparatus comprising a power source, a mineral cell, and a conduit.

FIG. 17 depicts a perspective view of the FIG. 16 mineral cell without electrode plates.

FIG. 18 depicts side views of a pin and a power source.

FIG. 19 depicts cross-sectional views of the FIG. 18 pin and power source.

FIG. 20 depicts a side view of a power source and a mineral cell without electrode plates.

FIG. 21 depicts a cross-sectional view of the FIG. 20 power source and mineral cell.

FIG. 22 depicts a cross-sectional view of a power source, a mineral cell with electrode plates, and a conduit.

FIG. 23 depicts a section view of a modified FIG. 22 power source and mineral cell.

Aspects of the examples illustrated in the drawings may be explained further by way of citations to the drawing and element numbers in the text of the description. The drawings and any citations thereto are provided for illustration purposes, and to further clarify the description of the present disclosure and are not intended to limit the present disclosure unless claimed.

### DETAILED DESCRIPTION

Aspects of the present disclosure are not limited to the exemplary structural details and component arrangements described in this description and shown in the accompanying drawings. Many aspects of this disclosure may be applicable to other aspects and/or capable of being practiced or carried out in various variants of use, including the examples described herein.

Throughout the written descriptions, specific details are set forth to provide a more thorough understanding to persons of ordinary skill in the art. For convenience and ease of description, some well-known aspects may be described conceptually to avoid unnecessarily obscuring the focus of this disclosure. In this regard, the written descriptions and accompanying drawings should be interpreted as illustrative rather than restrictive, enabling rather than limiting.

Exemplary aspects of this disclosure reference decontamination apparatus, kits, methods, and systems. For example, some aspects are described as having a mineral cell operable to ionize water contained in a pool or tub and a removeable power source that allows the mineral cell to be replaced separately therefrom. Unless claimed, these descriptions are provided for convenience and not intended to limit this disclosure. Accordingly, any aspects described in this disclosure with reference to any decontamination apparatus, kits, methods, and systems described herein may be similarly utilized with any comparable apparatus, kits, methods, and/or systems.

Several exemplary reference axes are described, including a lateral axis X-X, a longitudinal axis Y-Y, and a vertical axis Z-Z. Some elements and/or movements thereof are described relative to these axes, such as a first movement direction along one of axes X-X, Y-Y, and Z-Z that is opposite of a second movement direction along said one of axes X-X, Y-Y, and Z-Z. Axis Z-Z is generally shown as being vertical relative to the page so that terms like (i) above, up, upward, upper or (ii) below, down, downward, and lower may be oriented along axis Z-Z and described relative to a top and bottom of the page. Lateral axis X-X and longitudinal axis Y-Y may define a horizontal working plane, and various elements may be movable along or about vertical axis Z-Z in directions toward and away from the plane. As a further example, some objects may be described as “elongated,” meaning that they have a length greater than a width along a reference axis. Additional axes, movements, and forces may be similarly deployed. These relative terms are provided for convenience and do not limit this disclosure unless claimed.

Inclusive terms such as “comprises,” “comprising,” “includes,” “including,” and variations thereof, are intended to cover a non-exclusive inclusion, such that aspects of any apparatus, kit, method, and system described herein, or element(s) thereof described as comprising a list of elements does not include only those elements but may include other elements not expressly listed and/or inherent thereto. Unless stated otherwise, the term “exemplary” means “example” rather than “ideal.” Various terms of approximation may be used, including “approximately” and “generally.” Approximately means “roughly” or within 10% of a stated number or outcome and generally means “usually” or more than a 50% probability of a stated number or outcome.

Connective terms such as “attached to,” “attachable to,” and “attaching” are intended to generically describe a structural connection between two or more elements. Some structural connections may be “rigidly attached” or “permanently attached” so that the connected elements are generally non-rotatable relative to one another, as when the elements are formed together (e.g., cast, bolted, and/or welded) and cannot be rotated independently without deflecting relative to one another or being damaged and/or separated from one another without being damaged or destroyed. Other structural connections may be “rotatably or movably attached” so that the connected elements are coupled together to permit movements relative to one another, as when the elements are pinned together (e.g., with any type of rotating, sliding, and/or telescoping connection) and can be rotated or moved freely and independently without damage. Unless stated otherwise, these exemplary connective terms and their modifiers may comprise any such variations.

Aspects of an exemplary processor are described. Functional terms such as “processing,” “computing,” “calculating,” “determining,” “displaying,” and the like, may refer to actions and processes performable by the processor, which may comprise any type of software and/or hardware. The software may comprise program objects (e.g., lines of codes) executable to perform various functions. Each program object may comprise a sequence of operations leading to a desired result, such as an algorithm and/or instructions for interfacing with an AI-powered data analytics platform. The operations may require or involve physical manipulations of physical quantities, such as electrical or magnetic signals capable of being stored, transferred, combined, compared, and otherwise manipulated. The signals may be described conceptually as bits, characters, elements, numbers, symbols, terms, values, or the like.

The hardware of the processor may comprise any known technologies for storing the program objects and any data associated therewith. For example, the program objects may be stored in any machine (e.g., computer) readable storage medium in communication with the processor, including any mechanism for storing or transmitting data and information in a form readable by a machine (e.g., a computer). Exemplary storage mediums may comprise read only memory (“ROM”); random access memory (“RAM”); erasable programmable ROMs (“EPROMs”); electrically erasable programmable ROMs (“EEPROMs”); magnetic or optical cards or disks; flash memory devices; and/or any electrical, optical, acoustical, or other form of propagated signals (e.g., carrier waves, infrared signals, digital signals, etc.).

In keeping with above, the processor may be operable with one or more remote processor(s) or and/or sensor(s) over a wireless network, such an iPhone or other iOS device, an Android phone or other Android device, a Bluetooth or Wi-Fi enabled sensor, or the like.

Some aspects of the present disclosure are described with reference to methods, steps of which may be performable with the processor. To help orient the reader, some methods may be described with reference to a conceptual drawing, such as a flowchart with boxes interconnected by arrows; and/or a structural depiction, such as a figure that expressly or inherently communicates method steps performable with a particular structure. Each box may represent a particular step or technology. The boxes may be combined, interconnected, and/or interchanged to provide options for additional modifications according to this disclosure. The arrows may define an exemplary sequence of operation for the steps, the order of which may be important. For example, a particular order of the steps may describe a sequence of operation that is performable by the computing element to realize specific processing benefits, such as improving a computational performance and/or an operational efficiency. The structural depiction may utilize representations of axes, movements, and/or forces to communicate the method steps in view of this description.

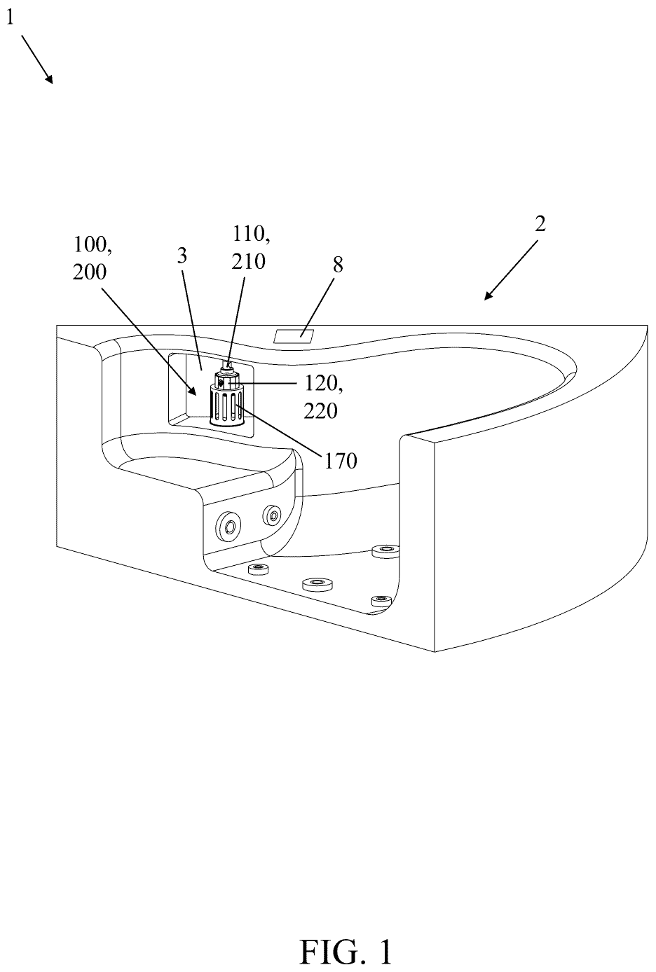

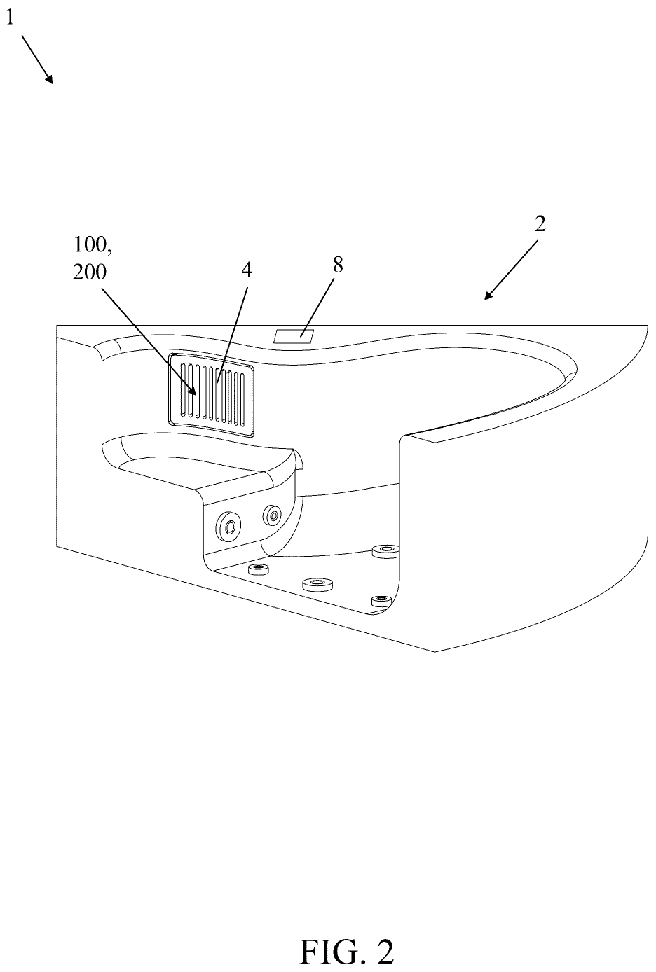

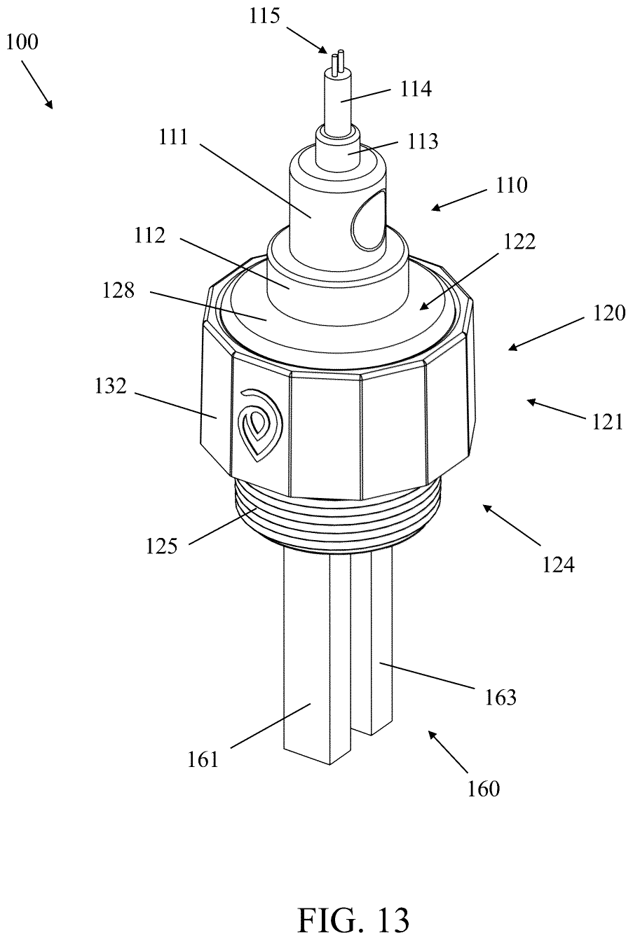

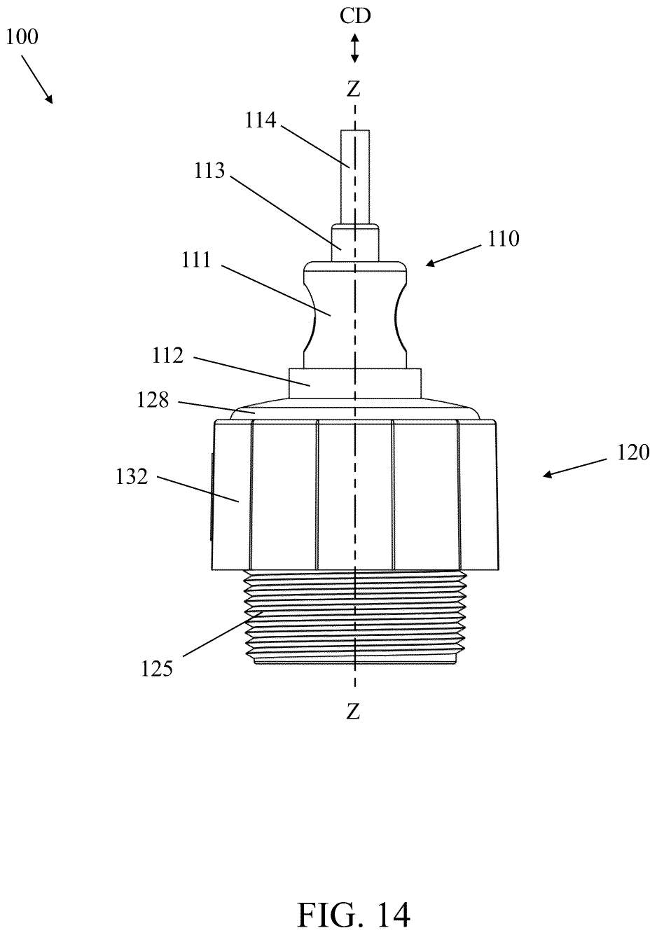

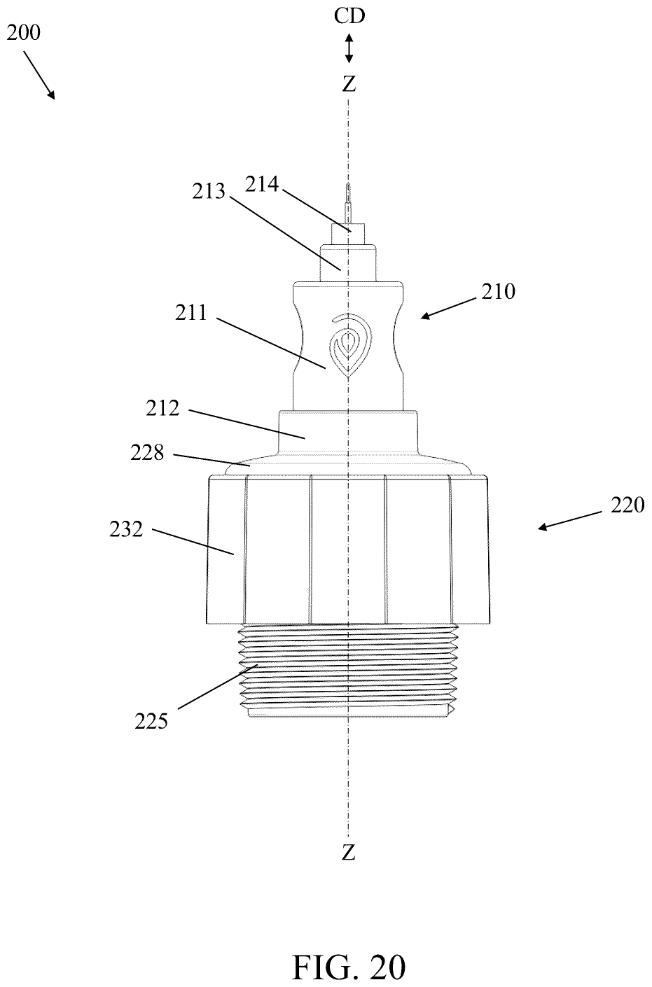

General aspects of this disclosure are now described with reference to exemplary decontamination apparatus 100, 200, and combinations thereof shown in FIGS. 1-23. As shown in FIG. 1, an exemplary pool system 1 may comprise a pool or tub 2 with a decontamination chamber 3 that contains decontamination apparatus 100, 200 and a controller 8 that is operable with decontamination apparatus 100, 200 to decontaminate water flowing in pool or tub 2. As shown in FIG. 2, a grille 4 may be removably attached to edges of decontamination chamber 3 and comprise openings or slots for permitting flows of water into and out of chamber 3 from pool or tub 2. As shown in FIGS. 1 and 2, controller 8 may be contained in a sealed portion of pool or tub 2 and in electrical communication with decontamination apparatus 100, 200 via a power source 110 that is rigidly attached to controller 8 and removably attached to decontamination apparatus 100, 200, allowing it to be replaced separately.

As disclosed herein, decontamination apparatus 100, 200 may be electronically operable with when submerged in the water in pool or tub 2 to release positively charged mineral ions into the water that are attracted to negatively charged bacteria and algae cells in the water, converting them into chunks of dead cells that are collectable by a filter of system 1. Controller 8 may be electronically operable with apparatus 100, 200 when submerged. Because the mineral ions output by decontamination apparatus 100, 200 are pH neutral and non-corrosive, the water in pool or tub 2 may have a stable pH for long periods (e.g., months) and apparatus 100, 200 may be compatible with other components of system 1, such as salt chlorine generator for pool or tub 2.

Exemplary aspects of this disclosure are now described with reference to exemplary decontamination apparatus 100 and related kits, methods, and/or systems like those shown conceptually in FIGS. 1-15.

As shown in FIGS. 1, 3, 4, and/or 6, decontamination apparatus 100 may comprise a power source 110, a mineral cell 120, and a conduit 170. Mineral cell 120 may contain elements that wear down over time (e.g., months) to release that positively charged mineral ions, requiring it to be replaced at regular intervals. To reduce operating costs, mineral cell 120 may be removably attached to power source 110 and conduit 170 to facilitate replacement of mineral cell 120 by itself, independent of power source 110 and conduit 170, allowing those components to be designed for even longer-term use (e.g., years) and re-used with a new mineral cell 120 rather than be thrown out with the old one. Aspects of mineral cell 120 may thus be described as analogous to a light bulb that is replaceable independent of a lamp and a lamp shade. As disclosed herein, power source 110 may be removably attached to mineral cell 120 to establish (i) an electrical connection between source 110 and cell 120; and (ii) one or more seal(s) 180 that prevent the water from disrupting the electrical connection when source 110 and cell 120 are submerged together.

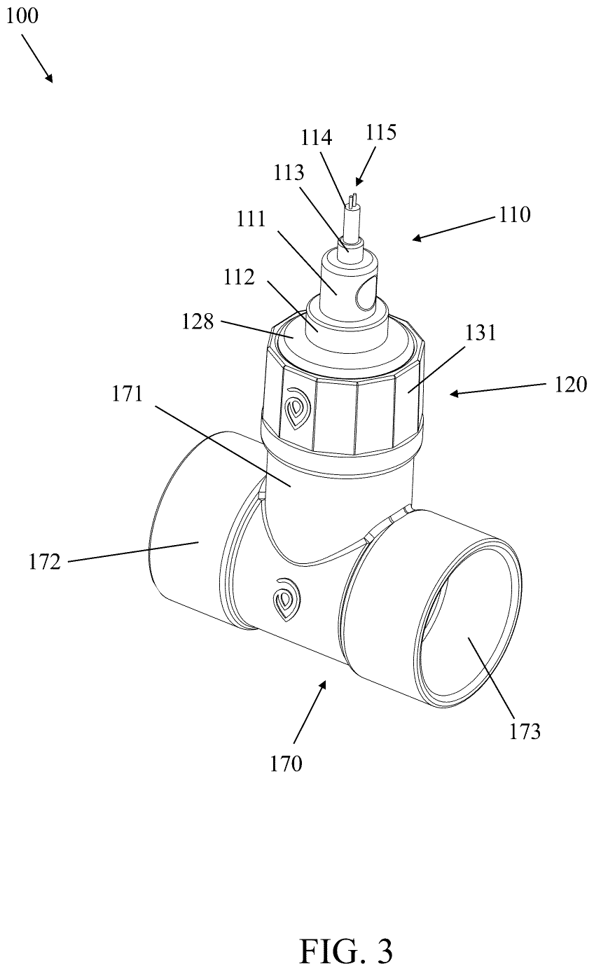

Particular aspects of power source 110, mineral call 120, conduit 170, and seal(s) 180 are now described by way of example. As shown in FIGS. 3, 4, 6, and/or 7, for example: (i) power source 110 may comprise a plug 111, a surround 112, a neck 113, a sheath 114, and conductors 115; and (ii) mineral cell 120 may comprise a housing 121, pin 140, and electrode plates 160.

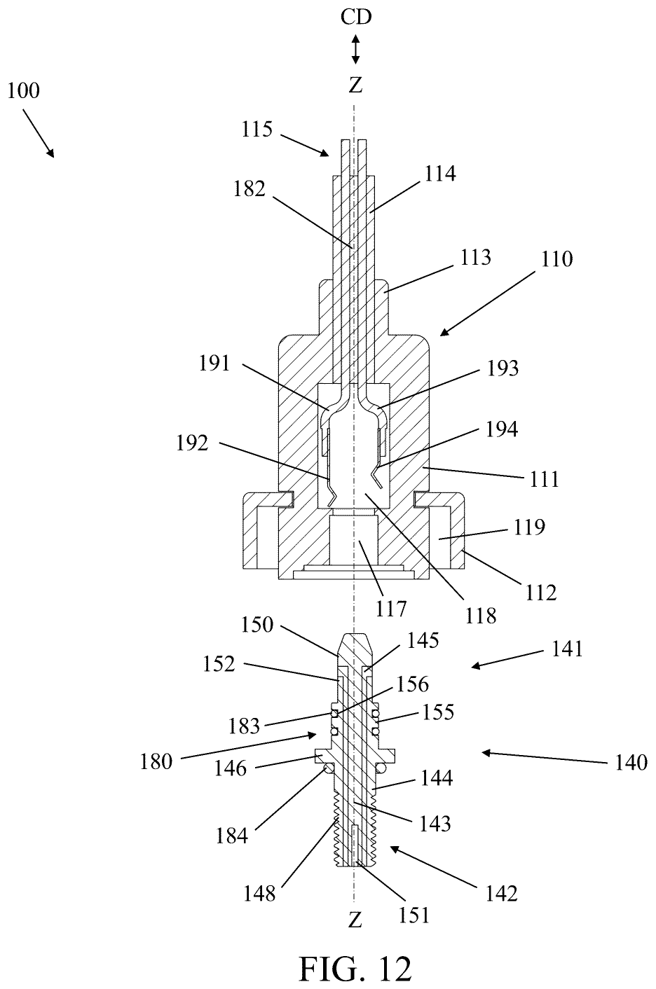

As shown in FIG. 12, plug 111 may comprise an elongated structure that extends along an axis Z-Z to define an interior portion comprising a shaft 117 leading to a bore 118. A diameter of shaft 117 about axis Z-Z may be smaller than a diameter of bore 118 about axis Z-Z so that shaft 117 may be described as narrowed relative to bore 118. As shown in FIG. 12, shaft 117 may comprise an entry recess having a diameter greater than a central portion of shaft 117 and an exit recess that is smaller than that of the central portion of shaft 117 so that it may be described as narrowing between a maximum diameter at the entry recess and a minimum diameter at the exit recess. As shown in FIG. 12, bore 118 may be sized to contain an electrical connection between end portions of conductors 115 and pin 140.

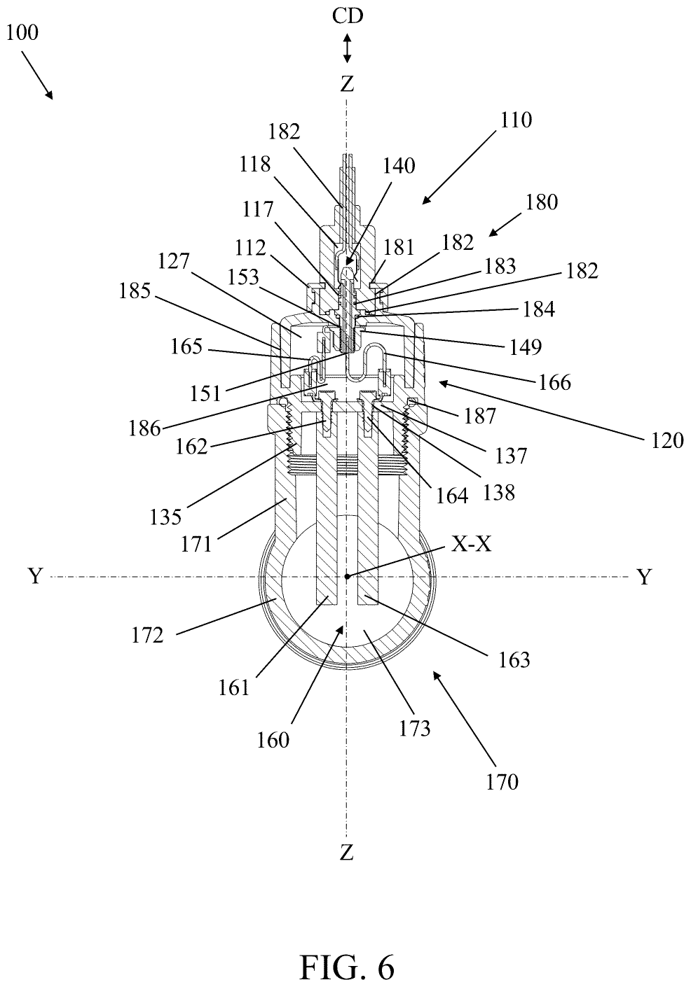

As shown in FIG. 12, surround 112 may extend outwardly from a front wall of plug 111 to define an annular space 119 between interior surfaces of surround 112 and exterior surfaces of plug 111. Surround 112 may be formed integral with or removably attached to plug 111. As shown in FIGS. 6 and 12, interior edges of surround 112 may be inserted into grooves on the exterior surfaces of plug 111 to removably attach surround 112 and plug 111. Aspects of seal 180 may comprise a first seal 181 established by a fit between the interior edges of surround 112 and the grooves of plug 111 and an adhesive in the grooves that prevents water from entering bore 118 through gaps between plug 111 and surround 112 when power source 110 and mineral cell 120 are submerged together. A different material may be used for surround 112, such as a flexible, rubberized material operable to improve seal 181 and/or eliminate the adhesive.

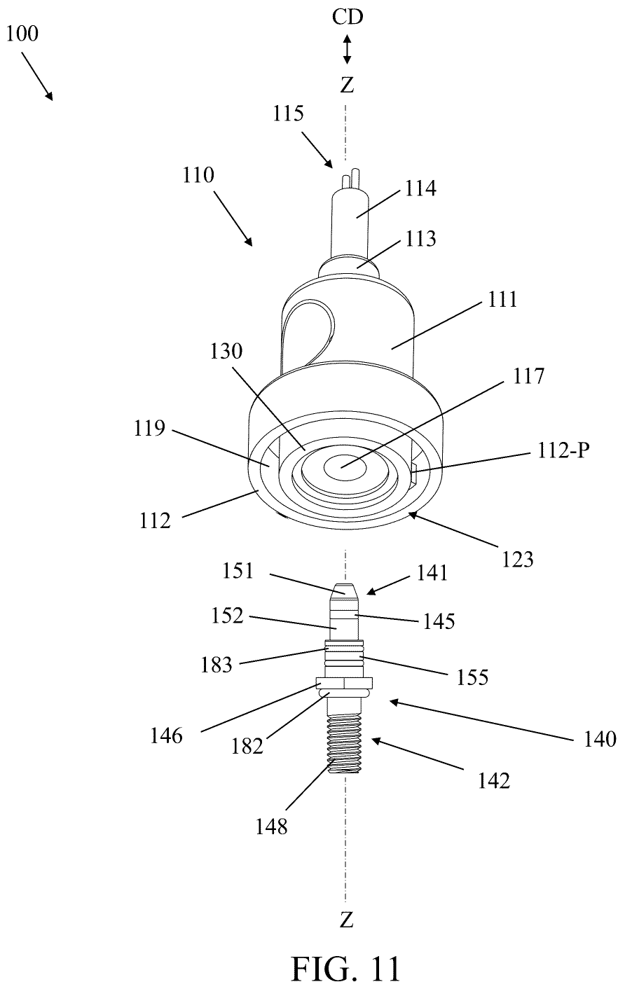

As shown in FIGS. 6 and/or 7, an interior surface of surround 112 may comprise a locking structure operable with a corresponding attachment structure of mineral cell 120 to removably attach it to plug 111. As shown in FIG. 11, the locking structure of surround 112 may comprise a cylindrical male side of a bayonet lock, such as a protrusion 112-P.

As shown in FIGS. 3, 4, and 12, neck 113 may extend outwardly from a rear wall of plug 111 along axis Z-Z. Sheath 114 may comprise an electrically insulative material extending from bore 118, through plug 111 and neck 113, and out of neck 113 away from plug 111. Conductors 115 may extend through sheath 114 from a first end portion inside of bore 118 and a second end portion that is electrically connected to controller 8. As shown in FIG. 1, controller 8 may comprise a first electrical connection to the grid (e.g., via a 120V connection) inside the sealed portion of pool or tub 2, a second electrical connection with the second end of conductors 115 in the sealed portion of pool or tub 2, and a local processor operable to power decontamination apparatus 100 via the first and second electrical connections. One or both of the first electrical connection and the second electrical connection of controller 8 may be removably attachable, allowing each of controller 8, power source 110, mineral cell 120 to be replaced independently. For example, the second electrical connection of controller 8 may comprise a first end at which sheath 114 and conductors 115 are rigidly attached to a housing of controller 8 to ensure maximum water penetration prevention and a second end at which sheath 114 and conductors 115 are removably attached to plug 151 as described herein and thus re-usable with multiple mineral cells 120.

As shown in FIG. 12, aspects of seal 180 may comprise a second seal 182 established by an interaction between surfaces of sheath 114, plug 111, conductors 115, and an adhesive located therebetween to prevent water from entering bore 118 through gaps between plug 111, sheath 114, and/or conductors 115 when power source 110 and mineral cell 120 are submerged.

An electrical connection between conductors 115 and pin 140 may be established in bore 118 when plug 111 is removably attached to mineral cell 120. A shown in FIG. 12, the end portion of conductors 115 in bore 118 may comprise a first conductor 191, a first contact 192, a second conductor 193, and a second contact 194.

An end portion of first conductor 191 may comprise a rigid metallic structure operable to support first contact 192 from neck 113 and apply a first biasing force to pin 140 in a first direction oriented transversely with axis Z-Z, such as in a direction parallel to axis Y-Y. An end portion of second conductor 193 may similarly comprise another rigid metallic structure operable to support second contact 194 from neck 113 and apply a second biasing force to pin 140 in a second direction oriented transversely with axis Z-Z, such as in an opposite direction parallel to axis Y-Y. As shown in FIG. 12, each end portion of conductors 191, 193 may be cantilevered out of neck 113 and into bore 118, providing a support platform; and each of contacts 192, 194 may comprise a spring contact that is welded to and cantilevered from one of the support platforms. As shown in FIG. 12, end portions of contacts 192, 194 may flex relative to end portions of conductors 191, 193 in directions along axis Y-Y to accommodate pin 140. Contacts 192, 194 may comprise thin metal plates with protrusions extending toward axis Z-Z to contact pin 140, in which the remainder of each thin metal plate acts as a resilient beam operable to apply biasing forces to pin 140.

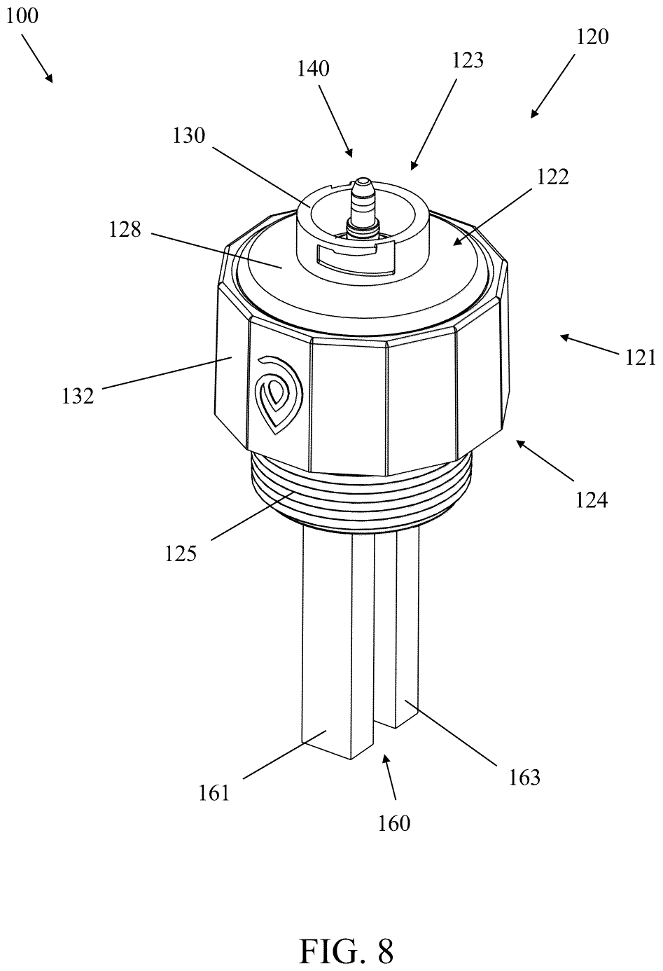

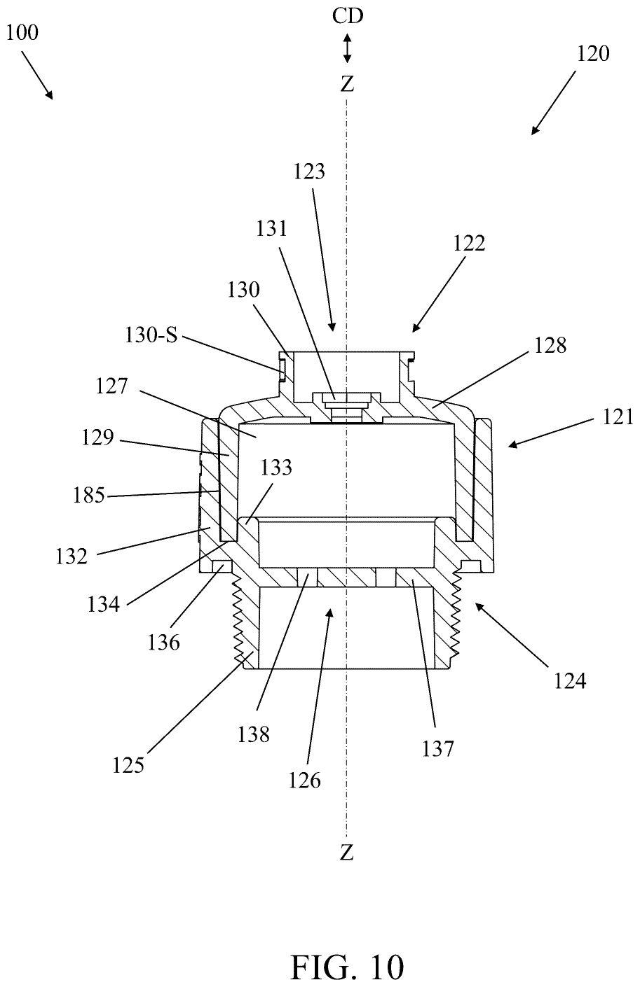

As shown in FIGS. 8, 10, and/or 12, mineral cell 120 may comprise a housing 121, pin 140, and electrode plates 160. As shown in FIG. 10, housing 121 may comprise a first housing 122, a power source interface 123, a second housing 124, a conduit interface 125, an electrode plate interface 126, and a chamber 127. First housing 122 may be removable attachable to second housing 124 to define chamber 127. As now described, aspects of seal 180 may comprise any combination of sealing and/or sealant technologies operable with first housing 122, power source interface 123, second housing 124, and electrode plate interface 126 to prevent water from entering chamber 127 when mineral cell 120 is submerged, with or without power source 110.

As shown in FIG. 10, first housing 122 may comprise a first wall 128, a sidewall 129 extending outwardly from one side of first wall 128 along axis Z-Z, and power source interface 123.

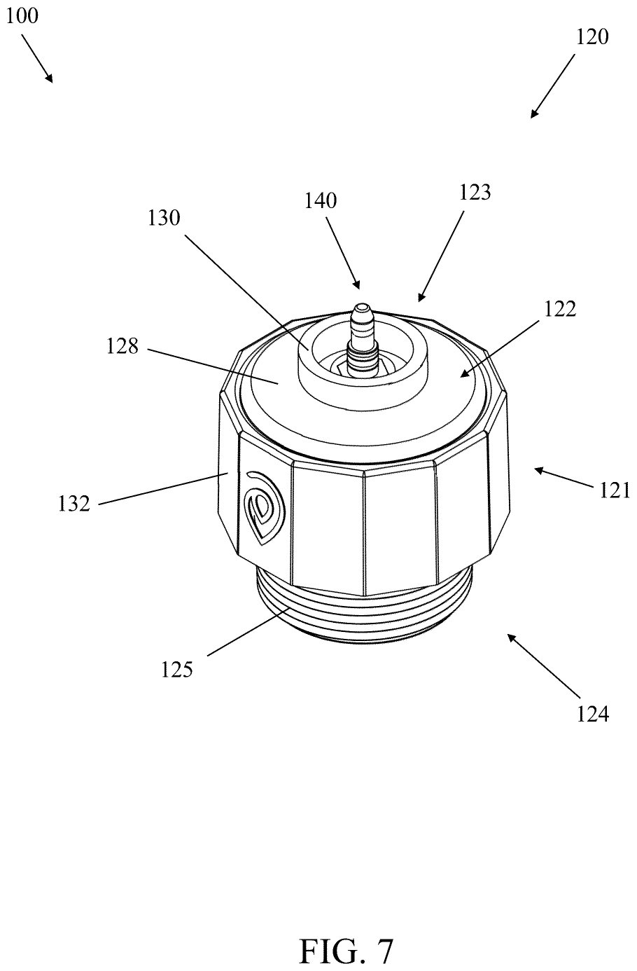

As shown in FIG. 10, power source interface 123 may comprise a perimeter wall 130 extending outwardly from first wall 128 along axis Z-Z and a hole 131 extending through first wall 128 along axis Z-Z. As shown in FIGS. 7, 8, and/or 9, first wall 128 may comprise a generally circular shape, sidewall 129 may comprise a generally cylindrical shape extending in one direction along axis Z-Z, and perimeter wall 130 may comprise a generally second cylindrical shape extending in an opposite direction along axis Z-Z.

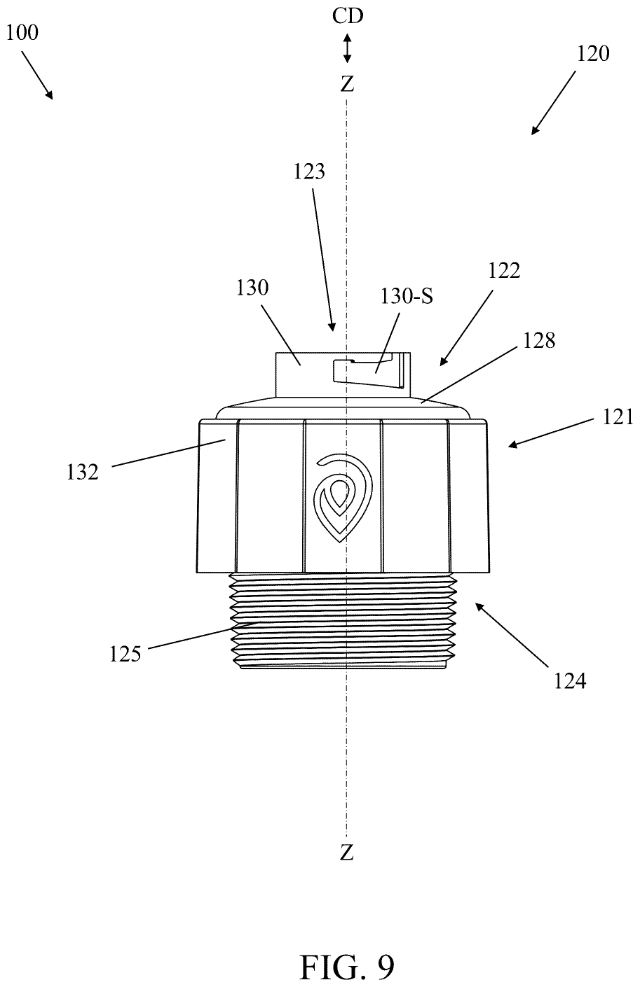

As shown in FIG. 10, perimeter wall 130 may comprise the corresponding structure operable with the locking structure of surround 112 to removably attach mineral cell 120 to plug 111. As shown in FIGS. 8, 9, and/or 10, perimeter wall 130 may comprise a female receptor portion of the aforementioned bayonet lock, such as a slot 130-S that is operable with protrusion 112-P (e.g., FIG. 11) to cell 120 onto plug 111.

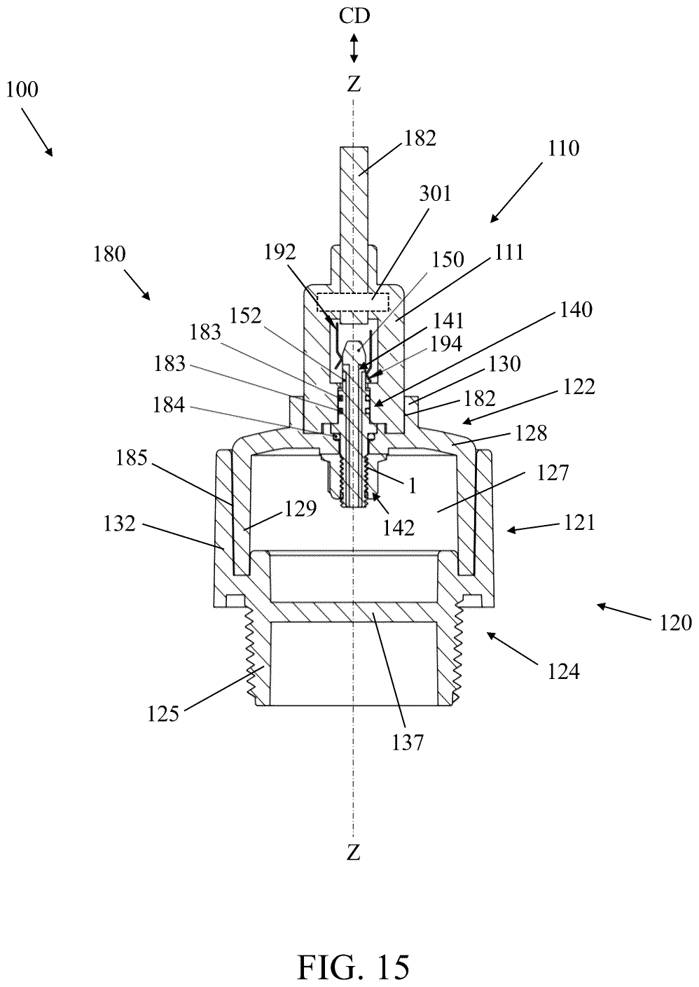

As shown in FIGS. 6, 10, 11, and 12, hole 131 may comprise a series of openings extending linearly through a thickened portion of first wall 128 along axis Z-Z. A diameter of an upper one of these openings about axis Z-Z may be smaller than a diameter of a lower one of these openings so that hole 131 may be described as narrowing between its upper and lower portions. As shown in FIG. 15, aspects of seal 180 may be operable with pin 140 and interior surfaces of one or more openings of the series or openings to prevent water from entering chamber 127 through gaps between exterior surfaces of pin 140 and said interior surfaces when mineral cell 120 is submerged.

Pin 140 may comprise a rigid structure that cantilevers outwardly from first housing 122 through hole 131 to establish an electrical connection with conductors 115 when the rigid structure is inserted into shaft 117. As shown in FIG. 15, pin 140 may comprise a first portion 141 extending away from first wall 128 of first housing 122 in a first direction along axis Z-Z and a second portion 142 extending away from first wall 128 into chamber 127 in a second direction along axis Z-Z.

Pin 140 may comprise an inner conductor 143, an outer conductor 144, an electrical insulator 145, a flange 146, threads 148, and a locking nut 149.

Inner conductor 143 and outer conductor 144 may be embedded in and part of the rigid structure of pin 140, an end of which may be removably attached to first wall 128 with locking nut 149. As shown in FIG. 12, inner conductor 143 may comprise a metallic beam element extending through a central portion of pin 140 between a plug contact 150 and an electrode contact 151. The metallic beam element may comprise an arrow shape with (i) a head that is received in bore 118 when pin 140 is inserted into shaft 117 and (ii) a stem located in the central portion of pin 140 below the head. As shown in FIG. 12, outer conductor 144 may comprise a metallic tube element extending around the stem, below the head, between a plug contact 152 and an electrode contact 153.

Plug contact 150, 152 may embedded in and part of first portion 141. As shown in FIG. 12, electrical insulator 145 may comprise a sleeve that is located between inner conductor 143 and outer conductor 144 to define the rigid structure of pin 140 by supporting contacts 150, 151, 152, 153; limiting deflections of plug contacts 150, 152 relative to first wall 128; and electrically insulating contacts 150, 152 from contacts 151, 153 from one another. The sleeve may extend through an interior portion of pin 140 to prevent electricity from conducting between inner conductor 143 and outer conductor 144. Electrical insulator 145 may be adhered to outer surfaces of inner conductor 143 and inner surfaces of outer conductor 144 to prevent water from entering bore 118 or chamber 127 through gaps between inner conductor 143, outer conductor 144, and electrical insulator 145 when mineral cell 120 is submerged.

Flange 146 may be located between first portion 141 and second portion 142 of pin 140. As shown in FIGS. 11 and/or 12, first portion 141 may extend away from flange 146 along axis Z-Z to establish a first electrical connection in bore 118 between first contact 192 and plug contact 150 and a second electrical connection between second contact 194 and plug contact 152 when the rigid structure of pin 140 is inserted into shaft 117 along axis Z-Z in connection direction “CD” and positioned to locate plug contacts 150 and 152 in bore 118.

Aspects of seal 180 may be operable to prevent water from entering bore 118 through shaft 117. As shown in FIG. 12, shaft 117 may comprise a narrowed portion proximate to its entry opening along axis Z-Z and first portion 141 of pin 140 may comprise a base 155 with a diameter along axis Z-Z that is sized to position exterior surfaces of base 155 adjacent interior surfaces the narrowed portion of shaft 117 when pin 140 is inserted. As shown in FIGS. 11, 12, and/or 15, base 155 may comprise one or more grooves 156 and aspects of seal 180 may comprise a third seal 183 located in each groove 156. Each third seal 183 may comprise an O-ring surrounding inner conductor 143, outer conductor 144, and electrical insulator 145. Base 155 may be sized to obtain a clearance fit with shaft 117. Each third seal 183 may expand outwardly from base 155 when outside of shaft 117, be compressible to permit entry of base 155 into the narrowed portion of shaft 117 and be resiliently expandable to seal shaft 117 around base 155.

As shown in FIGS. 11, 12, and/or 15, flange 146 may be received in an upper one of holes 131, aspects of seal 180 may comprise a fourth seal 184 established below flange 146, and the remainder of second portion 142 of pin 140 may pass into chamber 127 through another hole 131. Fourth seal 184 may comprise an O-ring that is compressible and resiliently expandable to prevent water from entering chamber 127 through gaps between flange 146 and hole 131. As shown in FIGS. 11, 12, and/or 15, threads 148 may be located on lower contact portion 142 and operable with corresponding threads on locking nut 149 to removably attach pin 140 to housing 121 and establish fourth seal 184 by pressing upper surfaces of locking nut 149 against interior surfaces of first wall 128, thereby compressing seal 184 between flange 146 and first wall 128 to fill the gaps.

As shown in FIGS. 10, second housing 124 may comprise an outer sidewall 132, an inner sidewall 133, an inner groove 134, a conduit interface 125, and an outer groove 136.

As shown in FIG. 10, outer sidewall 132 of second housing 124 may be sized to receive sidewall 129 of first housing 122 so that a lower edge of wall 130 is located in inner groove 134. Aspects of seal 180 may comprise a fifth seal 185 established between outer sidewall 132 of second housing 124 and sidewall 129 of first housing 122 to prevent water from entering chamber 127 through gaps between sidewalls 132 and 129 when mineral cell 120 is submerged. As shown in FIGS. 6 and/or 10, fifth seal 185 may comprise an adhesive or epoxy in inner groove 134 or other spaces between sidewalls 132, 129, and 133. As shown in FIG. 6, conduit interface 125 may comprise exterior threads operable with corresponding interior threads located interior surfaces of conduit 170 or vice versa.

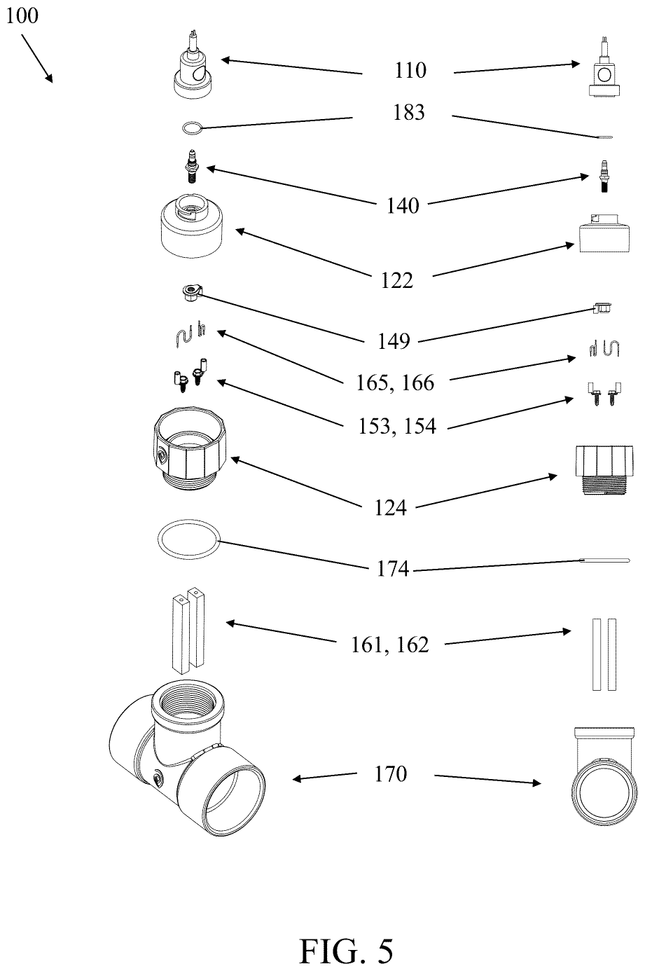

As shown in FIGS. 6, 8, 10, and/or 13, electrode plate interface 126 may comprise a support plate 137 with openings 138. Support plate 137 may extend between interior surfaces of inner sidewall 133 to provide a stable mounting platform for electrode plates 160. Openings 138 may extend through support plate 137 at spaced apart locations relative to axis Z-Z. Electrode plates 160 may extend outwardly from support plate 137 and be operable to ionize the water when submerged in the water and electrified. As shown in FIGS. 5 and/or 6, electrode plates 160 may comprise an electrode plate 161, a conductive screw 162, an electrode plate 163, and a conductive screw 164. Electrode plates 161, 163 may comprise an opposing pair of metal alloy electrode plates that are spaced apart from one another and electronically operable with conductors 143, 144 to release positively charged mineral ions into the water. As shown in FIG. 6, conductive attachment screws 162, 164 may comprise metal screws that extend through openings 138 to removably attached electrode plates 161, 163 to support plate 137. As shown in FIGS. 5 and/or 6, each conductive screw 162, 164 may be inserted into a threaded bore extending into of one of plates 161, 163 and operable to press each plate 161, 163 into support plate 137.

Electrical connections between electrode contacts 151, 153 and conductive attachment screws 162, 164 may be established inside of chamber 127. Aspects of seal 180 may be positioned to seal the electrical connections inside of chamber 127 and/or prevent the water from exiting chamber 127 through hole 131. As shown in FIG. 6, mineral cell 120 may comprise an intermediate conductor 165 extending between electrode contact 153 and conductive screw 162 and an intermediate conductor 166 extending between electrode contact 151 and conductive screw 164. Electrode contact 153 may comprise one of threads 148. Locking nut 149 may comprise a quick disconnect electrical connector that releasably establishes and an electrical connection between electrode contact 153 and one end of intermediate conductor 165. As shown in FIG. 6, a quick disconnect electrical connector may be used to establish an electrical connection between an opposite end of intermediate conductor 165 and conductive screw 162, completing a first conductive path between electrode contact 153 and electrode plate 160 via intermediate conductor 165. As shown in FIGS. 6 and/or 12, electrode contact 151 may comprise a bore extending into inner conductor 143 so that one end of intermediate conductor 166 may be inserted into the bore. As shown in FIG. 6, a quick disconnect electrical connector may be used to establish an electrical connection between an opposite end of intermediate conductor 166 and conductive screw 164, completing a second conductive path between electrode contact 151 and electrode plate 163 via intermediate conductor 166. The first and second conductive paths between contacts 151, 153, conductors 165, 166, screws 162, 164, and plates 160, 163 may be electrically insulated from one another.

Aspects of seal 180 may comprise a sixth seal 186 that is located in a lower portion of chamber 127 to prevent water from flowing into chamber 127 through gaps between conductive attachment screws 162, 164 and openings 138 when electrode bars 160 have worn down past screws 162, 164, exposing the gaps to the water. As shown in FIG. 6, sixth seal 186 may be temporarily established by engaging threads of conductive attachment screws 162, 164 with corresponding threads of electrode plates 160 until lower surfaces of screws 162, 164 are pressed against an upper surface of support plate 137 and upper surfaces of plates 160 are pressed against lower surfaces of support plate 137, forming a water-tight seal that prevents the water from entering chamber 127 through the aforementioned gaps until electrode bars 160 have worn down past screws 162, 164. In this example, the water may enter and/or flood chamber 127 through the gaps without affecting the performance of mineral cell 110 because it no longer has the ability to decontaminate the water and other aspects of seal(s) 180 may be utilized to stop the water from exiting chamber 127 through opening 131 and/or from exiting plug 111 through sheath 114.

As shown in FIG. 6, sixth seal 186 may be permanently established via a layer of epoxy that surrounds and structurally supports the second and third electrical connectors, sealing the aforementioned gaps by completely covering upper surfaces of conductive attachment screws 162, 164 within chamber 127. Open ends of the lower electrical connectors may be located above the epoxy of sixth seal 186 so that intermediate connectors 165, 166 may be connected to screws 162, 164 after the epoxy has cured. In this example, sixth seal 186 may prevent the water from entering or flooding chamber 127 without affecting the performance of mineral cell 110.

Aspects of seal(s) 180 may prevent the water from affecting the operation of controller 8 when decontamination apparatus 100 is submerged. For example, one or more seal(s) 180 may be operable to prevent the water from entering bore 118 from the sides (e.g., seals 181, 182, and/or 183), causing the water to disrupt the flow of electricity to electrode plates 160 by affecting the electrical connection between conductors 115 and pin 140. As a further example, one or more seal(s) 180 may be operable to prevent the water from entering bore 118 from below (e.g., seals 183, 184, 185, and/or 186), causing the water to disrupt the flow of electricity to electrode plates by travelling into bore 118, through interstitial spaces between sheath 114 and 115, and into controller 8, damaging its circuits. In this example, after electrode bars 160 have worn down past screws 162, 164, to expose the aforementioned gaps, the water may flow through hole 131 after flood chamber 127 before being stopped by one or more seals(s) 180 (e.g., seals 183, 184, and/or 185) or be prevented from flooding chamber 127 (e.g. by alternative seal 186), and yet stopped either way from flowing into controller 8 through the interstitial spaces.

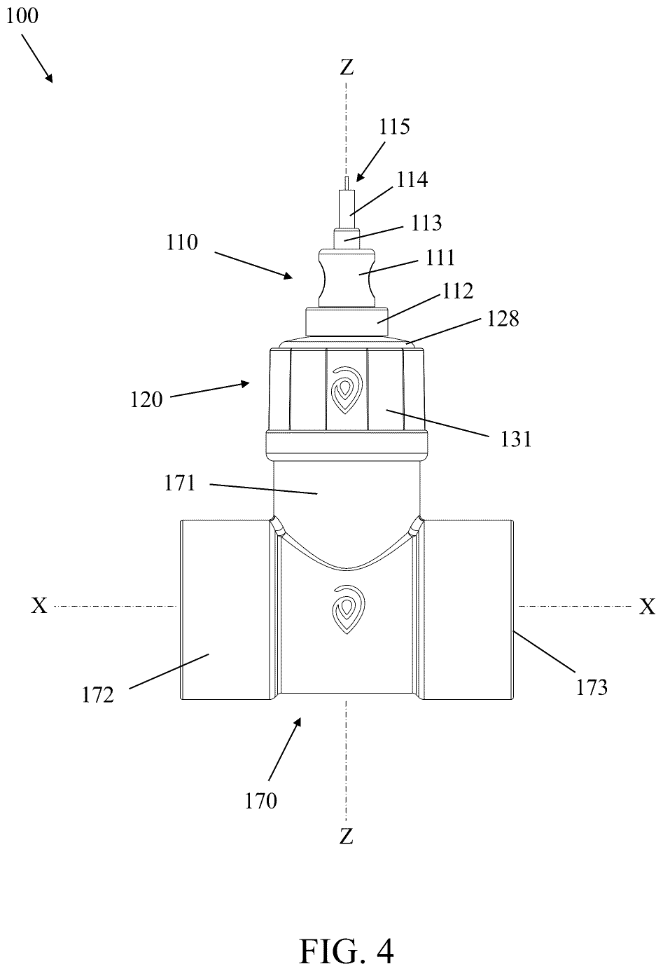

Conduit 170 may be removably attachable to mineral cell 120 and operable to direct flows of the water across electrode plates 160. As shown in FIGS. 3 and 4, conduit 170 may comprise an electrode containing portion 171 and a flow-directing portion 172. Electrode containing portion 171 may comprise a hollow tube extending along axis Z-Z from a threaded connection with conduit interface 125 to an intersection with flow-directing portion 172, which may comprise another hollow tube extending along axis Y-Y to define a flow channel 173 that directs the water across electrode plates 160 (e.g., FIG. 5). Decontamination apparatus 100 may comprise additional flow-directing devices and/or structures operable with conduit 170 to direct flows of water across electrode plates 160. As shown in FIG. 1, for example, conduit 170 may comprise a shroud that is located in decontamination chamber 3 and operable with decontamination apparatus 100 to promote flows of water across electrode plates 160.

As shown in FIG. 10, outer groove 136 of second housing 124 may be located above the threads of conduit interface 125. Aspects of seal 180 may comprise a seventh seal 187 that prevents the water from affecting the threaded interaction of conduit interface 125 and conduit 170. As shown in FIGS. 5 and 8, seventh seal 187 may comprise an O-ring that is compressible and expandable to close gaps between interface 125 and conduit 170 like that of third seal 183.

In keeping with above, mineral cell 120 may be assembled by a method comprising: (i) removably attaching pin 140 to first housing 122; (ii) establishing fourth seal 184; (iii) removably attaching electrode plates 160 to second housing 124; (iii) establishing an electrical connection between electrode contacts 151, 153 and conductive attachment screws 162, 164; (iv) establishing sixth seal 186; (v) forming chamber 127 by removably attaching first housing 122 to second housing 124; and (vi) establishing fifth seal 185 to prevent water from entering chamber 127 and affecting the electrical connection between contacts 151, 153 and screws 162, 164 when mineral cell 120 is submerged. When assembled accordingly, mineral cell 120 may be sold as a standalone replaceable product (cf., like a light bulb) that is ready to decontaminate water in pool or tub 2 once removably attached to power source 110 and conduit 170 and submerged in the water.

Power source 110 may be rigidly attached to controller 8 and re-used with each new mineral cell 120, allowing it to be sold with or without power source 110. As shown in FIG. 1, system 1 may comprise a plurality of interchangeable mineral cells 120, one power source 110, one conduit 170, and/or one controller 8; and a maintenance kit for use with system 1 may consist essentially of one or more interchangeable mineral cells 120. Conduit 170 may be sold with decontamination apparatus 100 or integrated into pool or tub 2, making that part of system 1, offer additional cost savings to those who manage a larger number of pools or tubs 2 and replacement inventories associated therewith. As a further example, system 1 also may comprise an enclosure or mount for defining decontamination chamber 3 and containing additional elements therein, like an electric pump for circulation, a filter, a salt chlorine generator, and/or any other related systems.

In keeping with above, decontamination apparatus 100 may be installed in pool or tub 2 and/or replaced by a method comprising: (i) removably attaching power source 110 to mineral cell 120; and (ii) removably attaching mineral cell 120 to conduit 170.

Removably attaching power source 110 to mineral cell 120 may comprise inserting pin 140 through shaft 117 to establish (i) a first portion of seal 180 between an interface surface of the plug and a corresponding interface surface of the mineral cell (e.g., second seal 182); (ii) a second portion of seal 180 between pin 140 and shaft 117 (e.g., third seal 183), (iii) an electrical connection between contacts 192, 194 and contacts 150, 151 in bore 118. The first and second portions of seal 180 prevent water from entering bore 118 and affecting the electrical connection between power source 110 and mineral cell 120 when removably attached to one another and submerged to expose electrode plates 160 to the water. As described herein, based on the approximate lengths of bore 118, pin 140, and perimeter wall 130 shown in FIG. 15, for example, each of the first portion and second portions of seal 180 (e.g., seals 182, 183) and the electrical connection may be established an approximately the same time.

Once assembled as disclosed herein, decontamination apparatus 100 may be operable with controller 8 to decontaminate the water in pool or tub 2 over an extended period of time (months) by a method comprising (i) submerging mineral cell 120 and conduit 170 in the water when removably attached to one another; (ii) causing, with controller 8, electricity to flow from power source 110 to electrode plates 160 of mineral cell 120; (iii) monitoring, with a processor of apparatus 100, sensory data regarding the viability of electrode plates 160 and/or the pH levels of the water; and/or (iv) sending, with the processor, alerts to a remote processor (e.g., via controller 8) when the sensory data indicates that mineral cell 120 should be replaced.

As shown in FIG. 15, power source 110 may comprise a processor 301 comprising a printed-circuit board that is sealed inside plug 111 and electrically connected to conductors 115, making it an always-on data gathering and outputting device for decontamination apparatus 100. Processor 301 may comprise circuitry for (i) operating switches or timers; (ii) gathering sensory data about electrode plates 160 and/or the water, such as via a local sensor in data communication with processor 301, such as an environmental sensor adjacent processor 301 (e.g., for light, motion, pH, temperature, etc.); (iii) gathering sensory data wirelessly from a remote sensor in pool or tub 2, such from a pool cleaning robot; (iv) gathering sensory and/or other data wired or wirelessly from another device in decontamination chamber 3, such as from a smart pump; (v) causing alerts based on the gathered data, such as with the data transmitter or an onboard LED operable when source 110 is submerged; and/or (vii) outputting the sensory data to a remote processer in data communication with processor 301, such as controller 8 and/or an iPhone® or comparable device in data communication with controller 8.

Causing the electricity to flow may thus comprise instructing, with controller 8 or processor 301, a switch or timer operable to electrify power source 110 at a particular time. Monitoring the sensory data may thus comprise receiving, with processer 301, over a wired or wireless data connection, the sensory data from a sensors of decontamination apparatus 100 and/or pool or tub 2 that is in data communication with processor 301. And sending the alerts may thus comprise transmitting, with processor 301, over the wired or wireless data connection, instructions to the remote processor (e.g., controller 8 or one in data communication therewith) when the sensory data indicates that electrode plates 160 are unable to release a sufficient amount of positively charged mineral ions and/or the pH level of the water is below 7.2 or above 7.8.

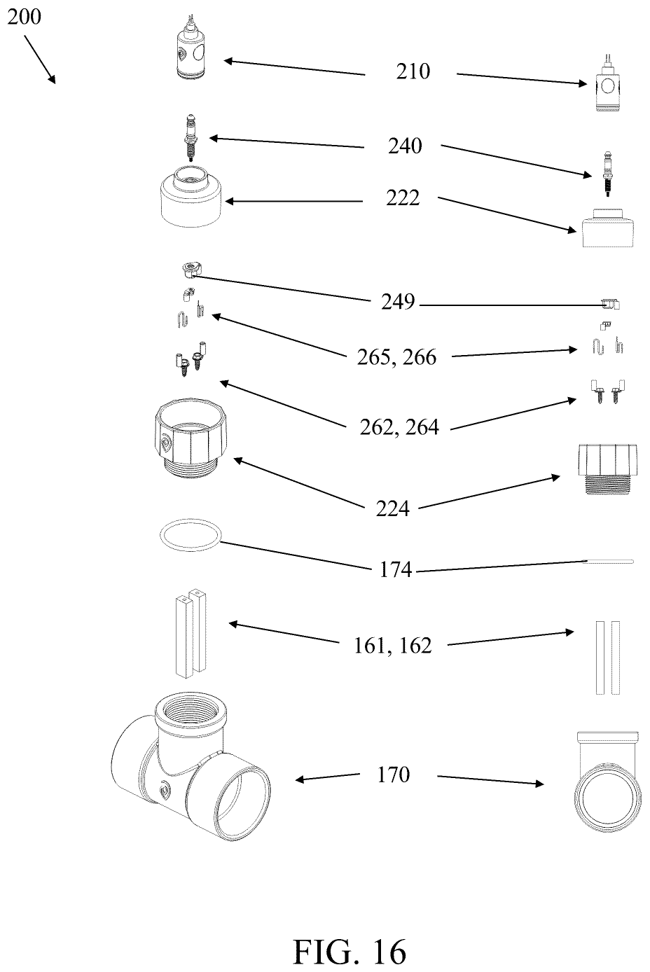

Exemplary aspects of this disclosure are now described with reference to exemplary decontamination apparatus 200 and related kits, methods, and/or systems like those shown conceptually in FIGS. 16-22.

Decontamination apparatus 200 may include reference numbers similar to those of decontamination apparatus 100, but within the respective 200 series of numbers, whether or not those numbers are expressly described and/or depicted in FIGS. 16-22. Any aspects described with reference to apparatus 100 or 200 may be included in any variations described herein, each possible combination or iteration being part of this disclosure. As shown in FIGS. 1 and 2 and noted above, exemplary pool or tub 2 with decontamination chamber 3 may similarly comprise decontamination apparatus 200 and controller 8, which may be similarly contained in pool or tub 2 and in electrical communication with decontamination apparatus 200 via a power source 210 that is rigidly attached to controller 8 and removably attached to apparatus 200, allowing it to be replaced separately.

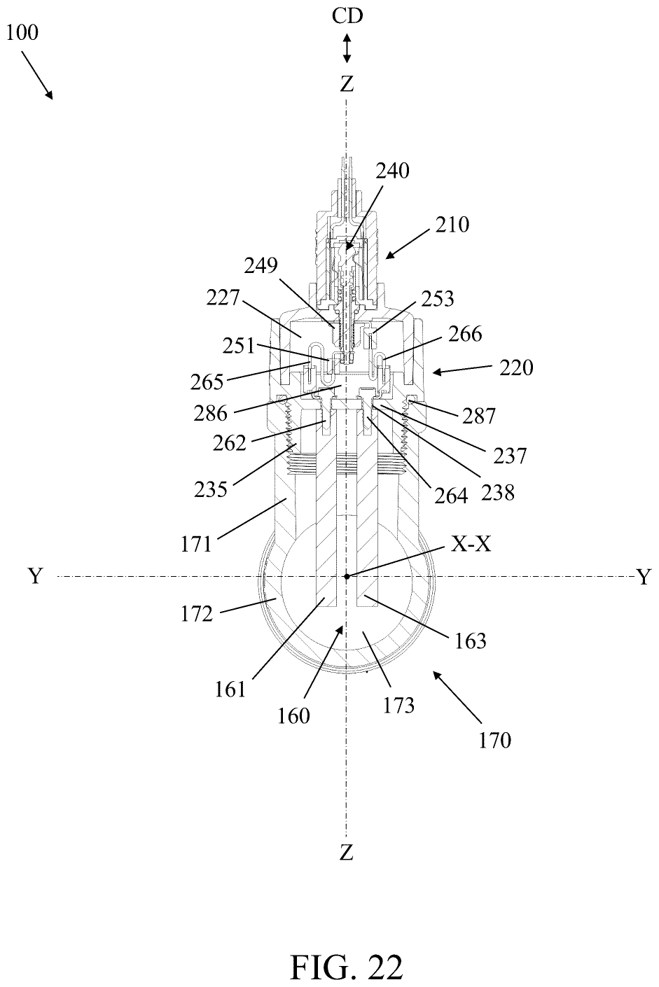

As shown in FIGS. 16 and 22, decontamination apparatus 200 may comprise a power source 210 and a mineral cell 220 that are similarly operable with conduit 170 described above. Mineral cell 220 may similarly contain elements that wear down over time (e.g., months) to release that positively charged mineral ions, requiring it to be replaced at regular intervals. To reduce operating costs, mineral cell 220 may be removably attached to power source 210 and conduit 170 to facilitate replacement of mineral cell 220 by itself, independent of power source 210 and conduit 170, allowing those components to be designed for even longer-term use (e.g., years) and re-used with a new mineral cell 220 rather than be thrown out with the old one. Aspects of mineral cell 220 may be similarly described as analogous to a light bulb that is replaceable independent of a lamp and a lamp shade, but with different types of electrical and structural connections. Similar to power source 110, power source 210 may be removably attached to mineral cell 220 to establish (i) an electrical connection between power source 210 and mineral cell 220; and (ii) one or more seal(s) 280 that prevent the water from disrupting the electrical connection when power source 210 and mineral cell 220 are removably attached to one another and submerged together. In complement to above, the electrical connection between power source 210 and mineral cell 220 also may simultaneously establish a structural connection that maintains one or more seal(s) 280 by preventing power source 210 from being detached from mineral cell 220.

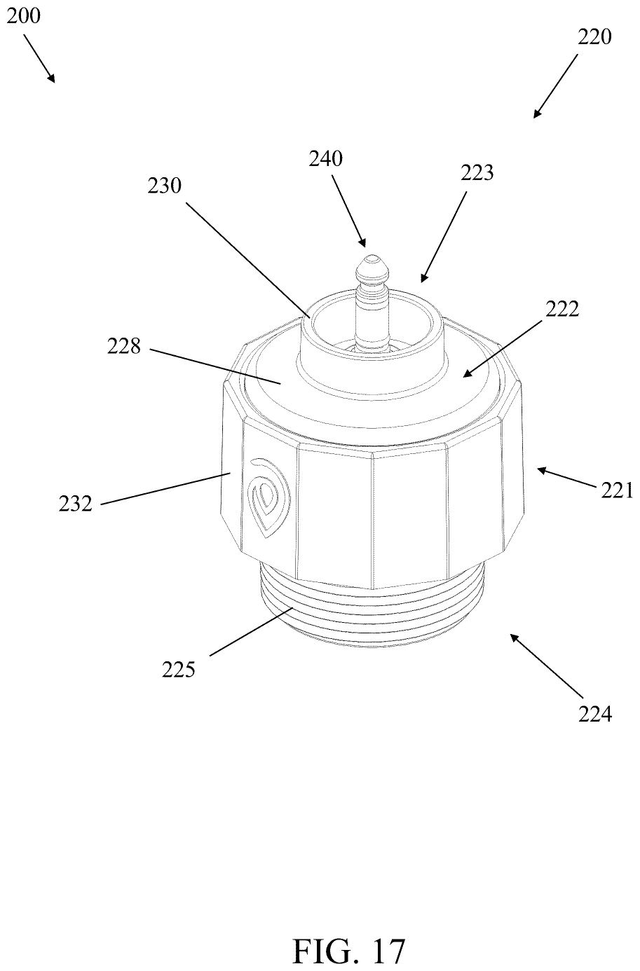

Particular aspects of power source 210, mineral cell 220, and seal(s) 280 are now described by reference to electrode plates 160 and conduit 170. As shown in FIGS. 16, 17, and/or 18, (i) power source 210 may comprise a plug 211, an interface surface 212, a neck 213, a sheath 214, conductors 215, and a sleeve 216 now described; and (ii) mineral cell 220 may comprise a housing 221, a pin 240, and electrode plates 160 described above.

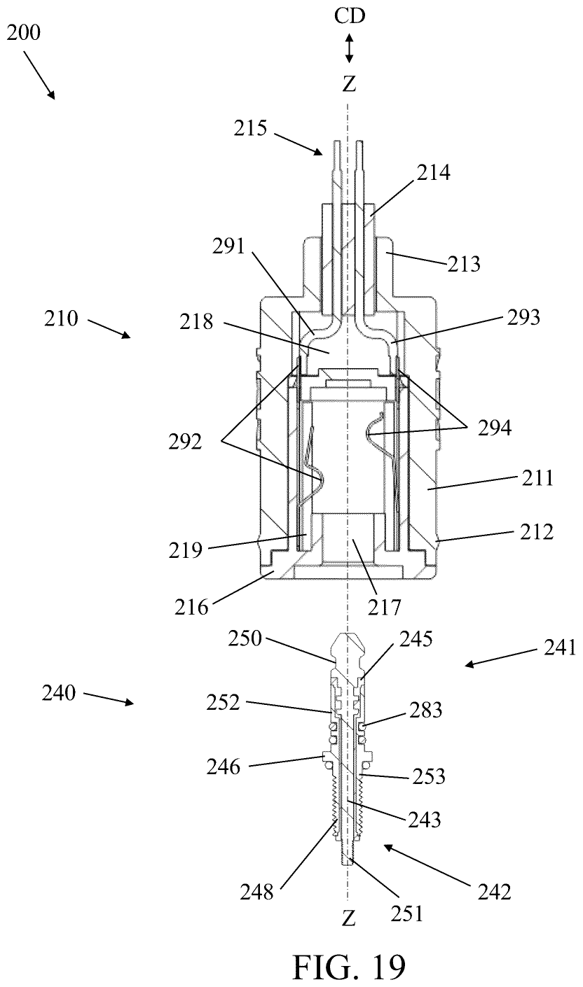

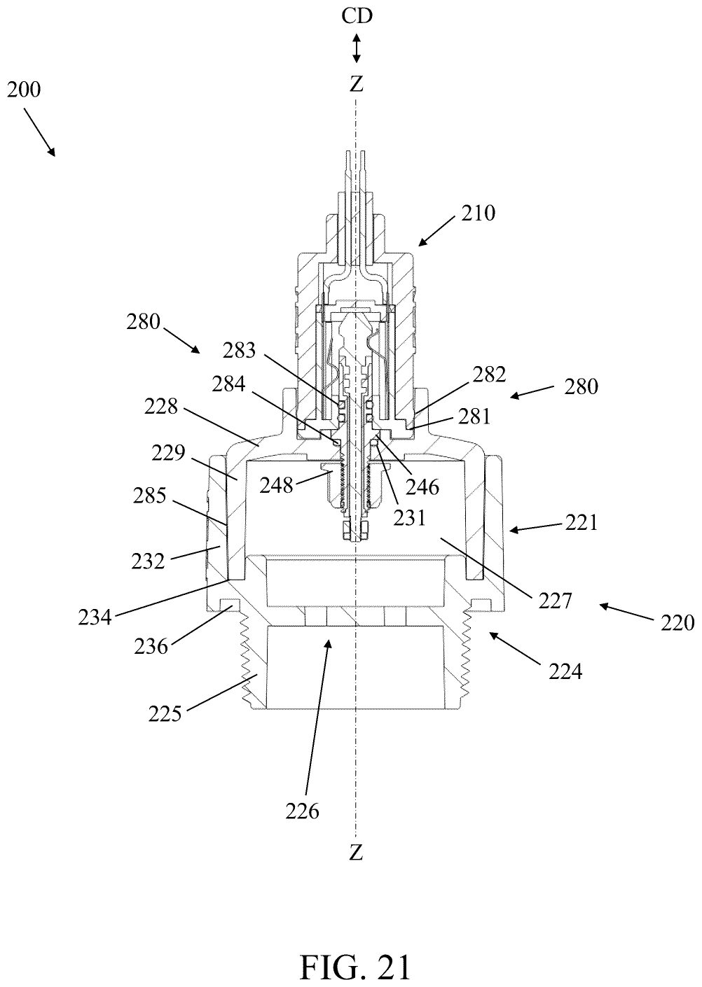

As shown in FIG. 19, plug 211 may comprise an elongated structure that extends along an axis Z-Z to define an interior portion comprising a bore 218. In complement to above, sleeve 216 may comprise an insulating structure with a complex 3D geometry (e.g., a tubular solid of revolution about axis Z-Z) that is inserted in bore 218 to define shaft 217. Sleeve 216 may be inserted into bore 218, attached to interior surfaces of plug 211, and positioned along axis Z-Z to define a sealed upper portion of bore 218. As shown in FIG. 21, aspects of seal(s) 280 may comprise interlocking structures of sleeve 216 and/or an adhesive operable with exterior surfaces of sleeve 216 and interior surfaces of bore 218 to define a first seal 281 that prevents water from entering the sealed upper portion of bore 218 via gaps between plug 111 and sleeve 216. As shown in FIG. 19, the exterior surfaces of sleeve 216 may comprise a cylinder with a “T” shaped cross-section, the interior surfaces of bore 218 may comprise a tube with a corresponding cross-section, the respective exterior and interior surfaces may interlock by obtaining a friction fit with one another when sleeve 216 is inserted into bore 218, and the adhesive may be utilized to reinforce the friction fit, helping to maintain first seal 281 over time.

Sleeve 216 may be formed (e.g., molded or 3D printed) of an electrically insulating polymeric material (e.g., acrylonitrile butadiene styrene or “ABS”) that has been shaped to define shaft 217 and the sealed upper portion of bore 218. As shown in FIG. 19, the complex 3D geometry of sleeve 216 may comprise an entry wall, a return wall, a sidewall, and an end wall. The entry wall may define an entry opening to shaft 117. The return wall may extend into bore 218 from the entry opening. Interior surfaces of the return wall may define shaft 117 along axis Z-Z. Exterior surfaces of the return wall may be spaced apart from the sidewall of sleeve 216 to define an interior annular space 219 extending partially along axis Z-Z. The end wall of sleeve 216 may attached to an end portion of the sidewalls and operable with an interior ledge of bore 218 to position sleeve 216 in bore 218 and define its upper sealed portion. As shown in FIG. 21, first seal 281 may be formed between interior surfaces of bore 218 and exterior surfaces of end wall 303 and sidewalls 302, and be operable to prevent water from entering the sealed upper portion of bore 218 through shaft 217.

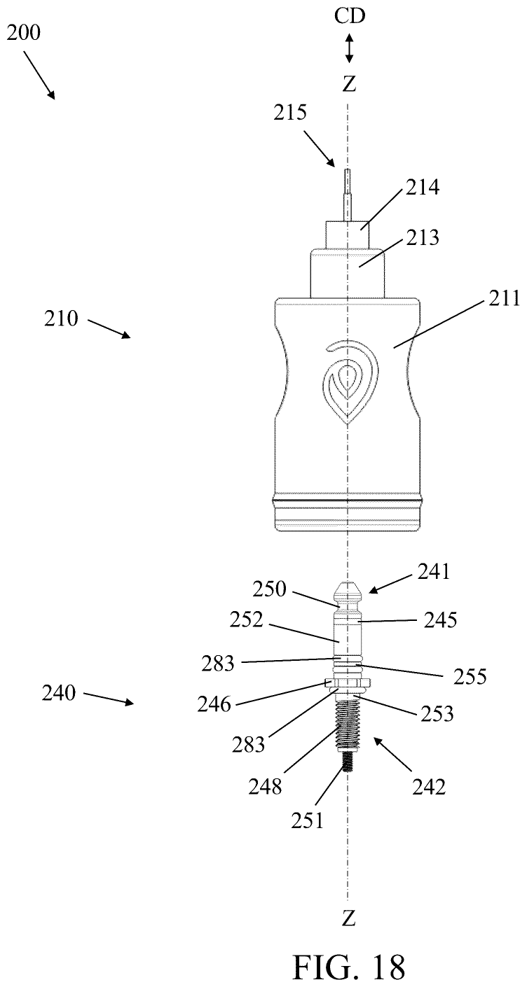

Interface surface 212 may comprise exterior surfaces of plug 211 (e.g., FIG. 18) that are operable with corresponding interior surfaces of mineral cell 220 (e.g., FIG. 17) to establish a close and/or friction fit that prevents water from entering bore 218 when plug 211 is removably attached to cell 220 and submerged. As shown in FIG. 22, aspects of seal 280 may comprise a second seal 282 established by the fit between interface surface 212 and mineral cell 220 when power source 210 is removably attached to cell 220. Second seal 282 may be operable to prevent water from entering shaft 217 and/or bore 218 through gaps between interface surface 212 (e.g., the exterior surfaces of plug 211, as shown in FIG. 18) and corresponding interior surfaces and mineral cell 220.

Interface surface 212 may comprise structural features that are located on and/or attached to the exterior surfaces of plug 211. As shown in FIG. 18, the structural features may comprise a rounded protrusion that extends outwardly from the exterior surfaces of plug 211 and is compressible against the corresponding interior surfaces of mineral cell 220 to establish a friction fit that forms second seal 282 with a minimum amount of surface area attachment, helping to prevent water from entering bore 218 from the side and optimize the pull-out forces required to detach plug 211 from mineral cell 220. Similar to as shown in FIG. 18, the structural features may alternatively comprise a groove that extends into exterior surfaces of plug 211 to receive an O-ring that is similarly operable to form second seal 282 and optimize its pull-out forces.

As shown in FIGS. 6 and/or 7, surround 112 of plug 111 may be described with reference to a locking structure that is operable with a corresponding structure of mineral cell 120 to removably attach it to plug 111, e.g., like a bayonet lock. By comparison, as shown in FIGS. 17, 20, 21, and/or 22, interface surface 212 and the corresponding interior surfaces of cell 220 may be described without reference to a similar locking structure because aspects of second seal 282 and the electrical connection between conductors 215 and pin 240 may be configured to establish a structural connection that prevents power source 210 from being detached from mineral cell 220 after the electrical connection has been made, similar to a locking structure.

As shown in FIGS. 19, 21, and/or 22, the electrical connection between conductors 215 and pin 240 may be established in bore 218 when plug 211 is removably attached to mineral cell 220. As shown in FIG. 19, conductors 215 may comprise a first conductor 291, a first contact 292, a second conductor 293, and a second contact 294. First and second conductors 291, 293 may pass through neck 213 and into the sealed upper portion of bore 218. First and second contacts 292, 294 may comprise bent metal plates shaped to form resilient (e.g., metallic) structures operable to apply retaining forces to pin 240 when inserted into bore 218. As shown in FIG. 19, the bent metal plates of contacts 292, 294 may comprise (i) connecting ends that are conductively attached to conductors 291, 293, inside the sealed upper portion of bore 218; and (ii) conductive legs that extend into interior annular space 219. The conductive legs may assume any geometric configuration operable with plug 211 and/or sleeve 216 to apply the retaining forces to pin 240 in one or more directions relative to axis Z-Z when inserted into shaft 217 and bore 218. As shown in FIG. 19, the bent metal plates may be attached to sleeve 216 to form an assembly that is insertable into bore 218 after conductively attaching their connecting ends to conductors 291, 293.

As shown in FIG. 19, each conductive leg of contacts 292, 294 may comprise a straight elongated portion that extends along axis Z-Z from its connecting end toward a bend or joint; and a curved elongated portion extends away from the bend or joint, out of interior annular space 219, and through an opening of sleeve 216 towards axis Z-Z for conductive contact with pin 240. Each conductive leg of contacts 292, 294 may comprise a biasing shape operable like a spring to press a contact surface of the leg against pin 240 with retaining forces applicable thereto in one or more directions that are parallel and/or transverse with axis Z-Z. As shown in FIG. 19, each biasing shape of each conductive leg of contacts 292, 294 may comprise a protrusion that curves toward axis Z-Z and a foot located opposite of the bent portion. As shown in FIGS. 19, 21, and/or 22, the contact surfaces of contacts 292, 294 may be located on interior-facing faces of the protrusions and pressed against corresponding contact surfaces of pin 240 when inserted into shaft 217, causing compressive forces that are resolved by the protrusions into reaction forces that press the foots toward sleeve 216. As shown in FIG. 19, the foots may form sliding pinned connections with surfaces of sleeve 216 and/or bore 218 providing a limited degree of translation along axis Z-Z, thereby causing the contact surfaces of each conductive leg to apply the retaining forces in one or more directions relative to axis Z-Z when pin 240 is inserted into shaft 217.

Each conductive leg of contacts 292, 294 may be operable with a contact surface of pin 240 to apply the retaining forces. Different types of retaining forces may be applied to different contact surfaces of pin 240. As shown in FIG. 19, some retaining forces may applied in directions parallel to axis Z-Z, such as via a sliding connection between contact 292 and electrode contact 252 of pin 240 that generates friction forces when it is moved along axis Z-Z; whereas other retaining forces may be applied in directions that are parallel and transverse to axis Z-Z, such as via a keyed connection between the protrusion of contact 294 and a concave surface of electrode contact 250 of pin 240 (e.g., between the arrow-shaped head and ledge of pin 240) that generates friction forces and shear forces when it is moved along axis Z-Z. Because pin 240 is cylindrical, the retaining forces may be applied to its contact surfaces when pin 240 is move linearly along axis Z-Z and/or rotated about axis Z-Z, limiting vertical and rotational movements of plug 211 relative to mineral cell 220. As shown in FIG. 19, one or more contacts surface of contact 292 may be located in a lower portion of shaft 217 and one or more contact surfaces of contact 294 may be located in an upper portion of shaft 217, or vice versa, depending upon the configuration of pin 240.

As shown in FIGS. 16, 17, 18, and/or 21, for example, mineral cell 220 may comprise a housing 221, pin 240, and electrode plates 160 as described above; and housing 221 may comprise a first housing 222, a power source interface 223, a second housing 224, a conduit interface 225, an electrode plate interface 226, and a chamber 227. First housing 222 may be removable attachable to second housing 224 to define chamber 227. As shown in FIG. 21, seal 280 may comprise any combination of sealing and/or sealant technologies operable with first housing 222, power source interface 223, second housing 224, and electrode plate interface 226 to prevent water from entering chamber 227 when mineral cell 220 is submerged, with or without power source 210.

As shown in FIG. 17, first housing 222 may comprise a first wall 228, a sidewall 229 extending outwardly from one side of first wall 228 along axis Z-Z, and power source interface 223.

As shown in FIG. 17, power source interface 223 may comprise a perimeter wall 230 extending outwardly from first wall 228 along axis Z-Z and a hole 231 extending through first wall 228 along axis Z-Z. Similar to first wall 129, as shown in FIGS. 16, 17, 21, and/or 22, first wall 228 may comprise a generally circular shape, sidewall 229 may comprise a generally cylindrical shape extending in one direction along axis Z-Z, and perimeter wall 230 may comprise a generally second cylindrical shape extending in an opposite direction along axis Z-Z.

As shown in FIGS. 17 and/or 21, perimeter wall 230 may comprise the corresponding surface of mineral cell 220 and be operable with interface surface 212 to form second seal 282. As shown in FIG. 19, the rounded protrusion of interface surface 212 may extend outwardly from the exterior surfaces of plug 211 and be compressible against perimeter wall 230 to establish a friction fit that forms second seal 282 with a minimum amount of surface area attachment, helping to keep the water out of bore 218 in a configuration that is customizable (e.g., by changing the shape and/or material composition of the protrusion) to optimize the pull-out forces required to detach plug 211 from mineral cell 220 to ensure they fall with a human-operable range.

As shown in FIG. 21, aspects of hole 231 and corresponding portions of seal 280 may be similar to aspects of hole 131 and corresponding portions of seal 180 described above.

Pin 240 may comprise a rigid structure that cantilevers outwardly from first housing 222 through hole 231 to establish an electrical connection with conductors 215 when pin 240 is inserted into shaft 217. As shown in FIGS. 18, 19, 21, and/or 22, pin 240 may comprise a first portion 241 extending away from first wall 228 of first housing 222 in a first direction along axis Z-Z and a second portion 242 extending away from first wall 228 into chamber 227 in a second direction along axis Z-Z.

Similar to pin 140, pin 240 may comprise an inner conductor 243, an outer conductor 244, an electrical insulator 245, a flange 246, threads 248, and a locking nut 249.

Inner conductor 243 and outer conductor 244 may be embedded in and part of the rigid structure of pin 240, an end of which may be removably attached to first wall 228 with locking nut 249 (e.g., as shown in FIGS. 21 and/or 22, similar to first wall 128 and locking nut 149 of FIG. 15). As shown in FIG. 19, inner conductor 243 may comprise a metallic beam element extending through a central portion of pin 240 between a plug contact 250 inside of shaft 217 and an electrode contact 251 inside of chamber 227. As shown in FIGS. 19 and/or 21, the metallic beam element of inner conductor 243 may comprise (i) an arrow-shaped head defining a cone that is received in bore 118 when pin 240 is inserted into shaft 117; (ii) a cylindrical groove that extends around pin 240 to define a concave surface located below the arrow-shaped head; (iii) a cylindrical ledge located below the concave surface of the groove; and (iv) a cylindrical stem that has a diameter smaller than that of the cylindrical ledge and is located in the central portion of pin 240 below the cylindrical ledge head, in which (v) plug contact 250 comprises the concave surface defined by the groove. As shown in FIGS. 19 and/or 21, outer conductor 244 may comprise a metallic tube element extending around the stem of inner conductor 243, below its arrow-shaped head, between a plug contact 252 and an electrode contact 253 located inside of chamber 227.

Plug contacts 250, 252 may be embedded in and part of first portion 241 of pin 240. As shown in FIG. 19, electrical insulator 245 may comprise a sleeve that is located between inner conductor 243 and outer conductor 244 to define the rigid structure of pin 240 by supporting plug contacts 250, 252 and electrode contacts 251, 253, and limiting deflections of contacts 250, 252 and 251, 253 relative to end wall 228 while electrically insulating contacts 250, 251 from contacts 252, 253. The sleeve may extend through an interior portion of pin 240 to prevent electricity from conducting between inner conductor 243 and outer conductor 244. Electrical insulator 245 may be adhered to outer surfaces of inner conductor 243 below its ledge. As shown in FIG. 19, the outer surfaces of inner conductor 243 below the ledge may comprise ridges, interior surfaces of plug contact 252 may be located opposite of the ridges, and an upper portion of electrical insulator 245 may extend therebetween to further define the rigid structure of pin 240 and prevent water from entering bore 218 and/or chamber 227 through gaps between inner conductor 243, outer conductor 244, and electrical insulator 245 when mineral cell 220 is submerged.

Flange 246 may be located between first portion 241 and second portion 242 of pin 240. As shown FIG. 19, first portion 241 may extend away from flange 246 along axis Z-Z to establish (i) a first electrical connection in bore 218 between first contact 292 and plug contact 250; and (ii) a second electrical connection between second contact 294 and plug contact 252 when pin 240 is inserted into shaft 217 along axis Z-Z in connection direction “CD”.

Aspects of seal 280 may be operable to prevent water from entering bore 218 through shaft 217. As shown in FIG. 19, shaft 217 may comprise a narrowed portion proximate to its opening along axis Z-Z and first portion 241 of pin 240 may comprise a base 255 with a diameter along axis Z-Z that is sized to position exterior surfaces of base 255 adjacent interior surfaces the narrowed portion of shaft 217 when pin 240 is inserted. As shown in FIGS. 19, 21, and/or 22, base 255 may comprise one or more grooves 256 and aspects of seal 280 may comprise a third seal 283 located in each groove 256. Each third seal 283 may comprise an O-ring surrounding inner conductor 243, outer conductor 244, and electrical insulator 245. Base 255 may be sized to obtain a clearance fit with the narrowed portion of shaft 217. Each third seal 283 may expand outwardly from base 255 when outside of shaft 217 and be compressible to permit entry of base 255 into the narrowed portion of shaft 217 and resiliently expandable to seal shaft 217 around base 255.

As shown in FIGS. 21 and/or 22, flange 246 may be received in an upper one of holes 231, aspects of seal 280 may comprise a fourth seal 284 established below flange 246, and the remainder of second portion 242 of pin 240 may pass into chamber 227 through a lower one of holes 231. Fourth seal 284 may comprise an O-ring that is compressible and resiliently expandable to prevent water from entering chamber 227 through gaps between flange 246 and holes 231. As shown in FIG. 22, threads 248 may be located on lower contact portion 242 and operable with corresponding threads on locking nut 249 to removably attach pin 240 to housing 221 and establish fourth seal 284 by pressing upper surfaces of locking nut 249 against interior surfaces of first wall 228, thereby compressing the O-ring between flange 246 and first wall 228 to fill the gaps.

As shown in FIG. 21, second housing 224 may comprise an outer sidewall 232, an inner sidewall 233, an inner groove 234, a conduit interface 225, and an outer groove 236, aspects of which, such as a fifth seal 285 and conduit interface 225, may be similar to their counterparts described above.

Electrical connections between electrode contacts 251, 253 and conductive attachment screws 262, 264 may be established inside of chamber 227 and sealed therein by aspects of seal 280. As shown in FIG. 22, mineral cell 220 may comprise an intermediate conductor 265 extending between electrode contact 253 and conductive screw 262 and an intermediate conductor 266 extending between electrode contact 251 and conductive screw 264. Electrode contact 251 may comprise a quick disconnect connector that is conductively attached to an exterior surface of pin 240 (e.g., via an encircling conductor engaged with one of the threads), conductive screw 262 may comprise a quick disconnect connector that is conductively attached thereto inside of chamber 227 (e.g., via an encircling conductor that helps to establish sixth seal 286, like a washer), and intermediate conductor 265 may extend between the quick disconnect connectors, completing a first conductive path between electrode contact 153 and electrode plate 161 via intermediate conductor 265. Electrode contact 253 may comprise a quick disconnect connector that is conductively attached to a terminus of the stem of pin 240 (e.g., via a hole extending therethrough), conductive screw 262 may comprise a quick disconnect connector that is conductively attached thereto inside of chamber 227 (e.g., via an encircling conductor that helps to establish sixth seal 286, like a washer), and intermediate conductor 266 may extend between the quick disconnect connectors, completing a second conductive path between electrode contact 152 and electrode plate 163.

The first and second conductive paths between contacts 251, 253, conductors 265, 266, screws 262, 264, and plates 161, 163 may be electrically insulated from one another by aspects of seal 280, such as with a sixth seal 286 similar to sixth seal 186 described above.

Like decontamination apparatus 100, decontamination apparatus 200 also may be installed in pool or tub 2 and/or replaced by a method comprising: (i) removably attaching power source 210 to mineral cell 220; and (ii) removably attaching mineral cell 220 to conduit 170.

Removably attaching power source 210 to mineral cell 220 may comprise inserting pin 240 through shaft 217 to establish (i) a first portion of seal 280 between interface surface 212 of the plug 211 and perimeter wall 230 of mineral cell 220 (e.g., second seal 182); (ii) a second portion of seal 280 between pin 240 and shaft 217 (e.g., third seal 283), (iii) an electrical connection between contacts 292, 294 and plug contacts 250, 252 in bore 218, in which the first and second portions of seal 280 prevent water from entering bore 218 and affecting the electrical connection between power source 210 and mineral cell 220 when removably attached to one another and submerged to expose electrode plates 160 to the water. As described herein, based on the approximate lengths of bore 218, pin 240, and perimeter wall 230 shown in FIG. 22, for example, each of the first portion and second portions of seal 280 (e.g., seals 282, 283) and the electrical connection may be established at approximately the same time.

For decontamination apparatus 200, removably attaching power source 210 to mineral cell 220 also may comprise establishing a structural connection between plug 211 and pin 240 at approximately the same time. As shown in FIG. 19, the structural connection may be established by placing the conductive legs of contact 292, 294 in electrical communication with electrode contacts 250, 252 of pin 240. Placing the conductive leg of contact 292 may comprise causing its biasing portions to press its contact surface against plug contact 252 when pin 240 is fully inserted into shaft 217. Placing the conductive leg of contact 294 may similarly comprise causing its biasing portion to press its contact surface into a concave surface of plug contact 250 when pin 240 is fully inserted into shaft 217. As shown in FIG. 19, placing the conductive leg of contact 294 may comprise compressing the protrusion of contact 294 with the arrow-shaped head of pin 240 when partially inserted it into shaft 217, and allowing the protrusion to resiliently expand into the concave surface of electrode contact 250 when pin 240 is fully inserted.

Put another way, when the rigid structure of pin 240 is fully inserted into shaft 217 according to this method, the contact surface of contact 292 may be pressed into and against plug contact 252 of pin 240 by a biasing force that is applied by the protrusion of contact 292 (e.g., its resilient portion) and operable therewith to apply retaining forces pin 240 in directions that are parallel to axis Z-Z (e.g., via friction forces); and the contact surface of contact 294 may be pressed into and against plug contact 250 of pin 240 by a biasing force that is applied by the protrusion of contact 294 (e.g., its resilient portion) and operable therewith to apply retaining forces pin 240 in directions that are parallel and transverse to axis Z-Z (e.g., via friction forces.

Once assembled as disclosed herein, decontamination apparatus 200 may be operable with controller 8 to decontaminate the water in pool or tub 2 over an extended period of time (e.g., months) by a method comprising (i) submerging mineral cell 220 and conduit 170 in the water when removably attached to one another; (ii) causing, with controller 8, electricity to flow from power source 210 to electrode plates 160; (iii) monitoring, with a processor of apparatus 200, sensory data regarding the viability of electrode plates 160 and/or the characteristics of the water, such as pH levels; and/or (iv) sending, with the processor, alerts to a remote processor (e.g., via controller 8) when the sensory data indicates that mineral cell 220 should be replaced.

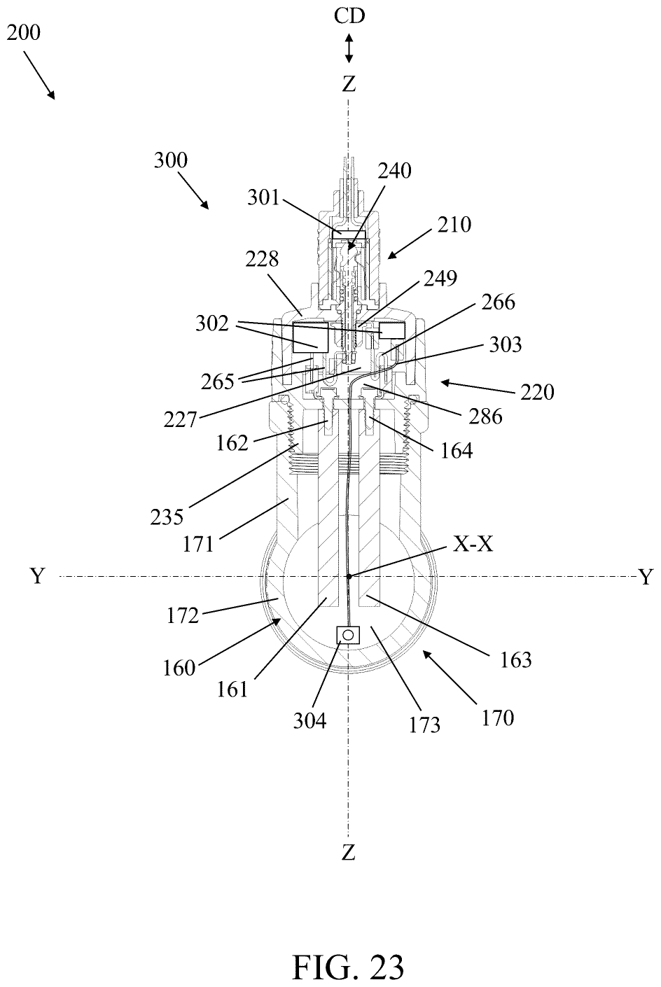

As shown in FIG. 23, power source 210 may comprise processor 301 described above, making it an always-on data gathering and outputting device for decontamination apparatus 200. As shown in FIG. 23, mineral cell 220 also may comprise a secondary processor 302, a data transmitter 303, and/or a conduit sensor 304. In complement to processor 301, secondary processor 302 may comprise additional circuitry for gathering sensory data about electrode plates 160 and/or the water with conduit sensor 304. For example, secondary processor 302 may comprise a printed circuit board with annular shape that is attached to interior surfaces of first wall 228 and comprises a central opening for locking nut 249. As shown in FIG. 23, the printed circuit board may be conductively attached to conductor 265, the quick disconnect connector for conductor 266, and an additional quick disconnect connector for data transmitter 303, allowing power and data to flow between second processor 302 and sensor 304.

Second processor 302 may be configured for wired (e.g., via power-line communications between pin 240 and contacts 292, 294) or wireless (e.g., via Bluetooth) data communication with processor 301 and/or controller 8. Data transmitter 303 may comprise a wire extending between the additional quick disconnect connector and sensor 304, allowing sensory data to be transmitted to second processor 302 from sensor 304 in real time. As shown in FIG. 23, data transmitter 303 may extend through a sealed opening of support plate 237 located between electrode plates 160 and into conduit 170 for placement in the water flowing therethrough. Sensor 304 may be positioned below and/or displaced away from electrode plates 160 along axis X-X (e.g., FIG. 4) to avoid electrical interference therewith. For example, data transmitter 303 may comprise an electrically shielded wire with a vertical portion that ends through support plate 237 along axis Z-Z and a horizontal portion that extends along axis X-X to a position sensor 304 at a location that is contained in conduit 170 (e.g., FIG. 4) and spaced apart from electrode plates 160.

As shown in FIG. 23, sensor 304 may comprise an environmental sensor that is located in the water and in data communication with processor 302, includes any combination of sensors for flow, light, motion, pH, temperature, etc., and is operable to output sensory data to a remote processer in data communication with processor 301, such as controller 8 and/or an iPhone® or comparable device in data communication with controller 8. As shown in FIGS. 4 and/or 22, power source 210, mineral cell 220, and conduit 170 sensor 304 may be attached to one another so that sensor 304 is positioned in flow-directing portion 172 or a flow channel 173 and operable with processors 301, 302 to automatically measure characteristics of the water, register small chemistry changes of the water, output precise readings (e.g., of chlorine and pH, calibrated to a particular pool or tub 2), and measure flow rates associated with conduit 170 and related elements, such as an electric pump for circulation, a filter, a salt chlorine generator, and the like.

While principles of the present disclosure are described herein with reference to illustrative aspects for particular applications, the disclosure is not limited thereto. Those having ordinary skill in the art and access to this disclosure will recognize additional modifications, applications, aspects, and substitution of equivalents all fall in the scope of the described aspects. Accordingly, the present disclosure is not to be considered as limited by the foregoing description.

1. An apparatus comprising:
a mineral cell comprising electrode plates and a pin comprising contacts; and
a power source comprising a plug defining a chamber, a shaft extending into the chamber, and conductors in the chamber,
the mineral cell being removably attachable to and operably submergible under water with the power source by inserting the pin through the shaft to establish:
an electrical connection in the chamber between the contacts and the conductors; and
a seal that prevents the water from entering the chamber when the electrode plates are submerged in the water and electrified via the electrical connection.

2. The apparatus of claim 1, wherein the electrode plates comprise a pair of metal alloy electrodes.

3. The apparatus of claim 1, wherein:
the mineral cell comprises a first wall, a second wall, and a sidewall extending between the first wall and the second wall to define a chamber; and
the pin comprises a first portion that cantilevers outwardly from the first wall to locate the contacts outside of the chamber and a second portion that is electrically connected to the electrode plates inside the chamber.

4. The apparatus of claim 3, wherein the first portion of the pin comprises a base that is sized to fit in the shaft and operable with interior surfaces of the plug and the shaft to establish the seal.

5. The apparatus of claim 4, wherein:
the base comprises a groove; and
the seal comprises an O-ring that is contained in the groove and has exterior surfaces operable with interior surfaces of the shaft to prevent the water from entering the chamber,
wherein the O-ring is compressible to permit entry of the pin into the shaft and expandable to seal the chamber.

6. The apparatus of claim 5, wherein the second portion of the pin is removably attached to the first wall of the mineral cell with a sealed connection that prevents the water from entering the chamber.

7. The apparatus of claim 6, wherein:
the pin comprises a flange located between the first portion and the second portion;
the first wall comprises a recess sized to obtain a clearance fit with an outer diameter of the flange; and
the sealed connection comprises an O-ring located in the recess below the flange.

8. The apparatus of claim 7, comprising a nut comprising threads operable with corresponding threads on the second portion to removably attach the pin to the front wall.

9. The apparatus of claim 1, wherein the pin comprises:
a first conductor extending through the pin and terminating at a first contact of the contacts;
a second conductor extending through the pin and terminating at a second contact of the contacts; and
an electrical insulator extending through the pin to prevent electricity from conducting between the first conductor and the second conductor,
wherein the first conductor is located in a central portion of pin, the second conductor is located in an outer portion of the pin, and the electrical insulator is located between and adhered to first conductor and the second conductor.

10. The apparatus of claim 9, wherein:
the seal comprises an O-ring surrounding the first conductor, the second conductor, and the electrical insulator; and
the O-ring is compressible to permit entry of the pin into the shaft and expandable to seal the chamber.

11. The apparatus of claim 10, wherein:
the first conductor comprises a stem extending through the central portion and a head that is located forward of the electrical insulator and comprises the first contact; and the second conductor comprises a tube surrounding the stem, the second contact comprises an end portion of the tube, and the electrical insulator is located between the head, the stem, and the tube.

12. The apparatus of claim 1, wherein each conductor of the conductors is operable, when the pin is located in the shaft, to apply a biasing force that maintains a physical contact between a surface of the conductor and a corresponding surface of one contact of the contacts.

13. The apparatus of claim 1, wherein:
the electrode plates comprises a first electrode plate and a second electrode plate;
the contacts comprises a first contact electrically connected to the first electrode plate and a second contact electrically connected to the second electrode plate;
the conductors comprise a first conductor operable to electrify the first electrode plate via the first contact and a second conductor operable to electrify the second electrode plate via the second contact when the pin is located in the shaft;
the first conductor applies a first biasing force to the first contact; and
the second conductor applies a second biasing force to the second contact.

14. The apparatus of claim 13, wherein the first conductor comprises a first spring contact operable to apply the first biasing force to the first contact and the second conductor comprises a second spring contact operable to apply the second biasing force to the second contact.

15. The apparatus of claim 14, wherein the first and second contacts comprise grooves, the first and second spring contacts comprises protrusions, and the first and second biasing forces are operable to retain the pin in the shaft by pressing the protrusions into the grooves.

16. The apparatus of claim 13, wherein:
the mineral chamber comprises a chamber;
the first contact is electrically connected to the first electrode plate in the chamber; and
the second contact is electrically connected to the second electrode plate in the chamber.

17. The apparatus of claim 16, comprising a nut that is located in the chamber and comprises threads operable with corresponding threads on the pin to:
removably attach the pin to the mineral cell; and
establish a sealed connection that prevents the water from entering the chamber.

18. The apparatus of claim 17, comprising:
a first intermediate connector that is located in the chamber to electrically connect the first conductor and the first electrode plate;
a first conductive screw that electronically connects the first intermediate conductor with the first electrode plate and removably attaches the first electrode plate to a support wall of the mineral cell;
a second intermediate connector that is located in the chamber to electrically connect the second conductor and the second electrode plate; and
a second conductive screw that electronically connects the second intermediate conductor with the second electrode plate and removably attaches the second electrode plate to the support wall.

19. The apparatus of claim 1, wherein:
the seal comprises a perimeter wall that extends outwardly from the mineral cell around the pin;
the plug interfaces with the perimeter wall and the mineral cell when the pin is inserted into the shaft to establish a perimeter seal that prevents the water from entering the shaft when the electrode plates are submerged in the water and electrified via the electrical connection; and
the perimeter seal comprises a friction fit obtained between exterior surfaces of the plug and interior surfaces of the perimeter wall.

20. The apparatus of claim 1, wherein:
a first end of the power source is rigidly attached to a controller; and
a second end of the power source is removably attachable to and operably submergible with the mineral cell.
